(19) United States
(12) Patent Application Publication
(10) Pub. No.: US 2025/0090992 A1
(43) Pub. Date: Mar. 20, 2025

(54) CONTAMINANT MANAGEMENT SYSTEM FOR CO2 CAPTURE SYSTEM

(71) Applicants: Glen Pomorski, Park Ridge, IL (US); Jeffrey Tyska, Roselle, IL (US); David Farr, Claremore, OK (US); Anh Ngo, Carol Stream, IL (US); Evan B. Jorgenson, Elgin, IL (US); Shubhra J. Bhadra, Naperville, IL (US); John D. Wilkinson, Midland, TX (US); Bradley Russell, Fall Branch, TN (US)

(72) Inventors: Glen Pomorski, Park Ridge, IL (US); Jeffrey Tyska, Roselle, IL (US); David Farr, Claremore, OK (US); Anh Ngo, Carol Stream, IL (US); Evan B. Jorgenson, Elgin, IL (US); Shubhra J. Bhadra, Naperville, IL (US); John D. Wilkinson, Midland, TX (US); Bradley Russell, Fall Branch, TN (US)

(21) Appl. No.: 18/749,230

(22) Filed: Jun. 20, 2024

Related U.S. Application Data
(60) Provisional application No. 63/583,989, filed on Sep. 20, 2023.

(51) Int. Cl. B01D 53/047

(52) U.S. Cl. CPC B01D 53/047; B01D 2256/22; B01D 2257/302; B01D 2257/404; B01D 2257/406; B01D 2258/0283; B01D 2259/40001

(57) ABSTRACT

Processes for removing contaminants in CO₂ recovery processes are described. The processes incorporate water wash units and/or NO₂—SO₂ removal section to remove sulfur oxide compounds and heavy nitric oxide compounds such as NO₂. Some processes include CO₂ PSA units and CO₂ fractionation columns, while others only use CO₂ PSA units. The CO₂ PSA concentrates CO₂ along with heavy nitric oxide compounds, SO₂ and NH₃. Optional quench columns, guard beds, particulate polishing units, and molecular sieves can be used remove HCl, HF, SO₂, SO₃, NH₃, hydrocarbons, mercury, and heavy metals.

### RELATED APPLICATIONS

This application claims priority to U.S. Provisional Patent Application Ser. No. 63/583,989, filed on Sep. 20, 2023, the entirety of which is incorporated herein by reference.

### BACKGROUND

CO₂ capture from flue gas is a key decarbonization strategy for various industries, such as steel, power and cement producers. Flue gas has contaminants that will cause the CO₂ product to be off spec (NO₂, SO₂, etc.) or cause issues in the PSA-Cryogenic system such as mercury issues with brazed aluminum exchanger, etc. The CO₂ capture technologies need to handle the various contaminants in the feed while minimizing the corresponding energy usage and cost.

There is a need for processes which efficiently capture CO₂ in gas feed streams, as well as remove impurities from the feed streams.

### BRIEF DESCRIPTION OF THE DRAWINGS

FIG. 1 is an illustration of one embodiment of an existing CO₂ recovery process with the CO₂ PSA unit before the CO₂ fractionation column.

FIG. 2 is an illustration of another embodiment of an existing CO₂ recovery process with the CO₂ fractionation column before the CO₂ PSA unit.

FIG. 3 is an illustration of one embodiment of a CO₂ recovery process with a high-pressure water wash unit according to the present invention.

FIG. 4A is an illustration of one embodiment of a recovery process with a NO₂/SO₂ removal section with a single cooling stage according to the present invention.

FIG. 4B is an illustration of one embodiment of a recovery process with a NO₂/SO₂ removal section with dual cooling stages according to the present invention.

FIG. 5 is an illustration of one embodiment of a recovery process with a high-pressure water wash unit and a NO₂/SO₂ removal section with a single cooling stage according to the present invention.

FIG. 6 is an illustration of one embodiment of a high-pressure water wash unit according to the present invention.

FIG. 7 is an illustration of one embodiment of a NO₂/SO₂ removal section with a single cooling stage according to the present invention.

FIG. 8 is an illustration of another embodiment of a NO₂/SO₂ removal section with a single cooling stage according to the present invention.

FIG. 9 is an illustration of one embodiment of a NO₂/SO₂ removal section with dual cooling stages according to the present invention.

FIG. 10 is an illustration of one embodiment of an integrated scheme for CO₂ capture according to the present invention.

FIG. 11 is an illustration of another embodiment of an integrated scheme for CO₂

capture according to the present invention.

FIG. 12 is an illustration of another embodiment of an integrated scheme for CO₂ capture according to the present invention.

FIG. 13 is an illustration of one embodiment of a CO₂ recovery processing with a CO₂ PSA and a high-pressure water wash unit according to the present invention.

FIG. 14 is an illustration of one embodiment of heat exchange in the process of FIG. 13.

FIG. 15 is an illustration of one embodiment of a CO₂ recovery processing with a CO₂ PSA and a scrubbing column according to the present invention.

### DETAILED DESCRIPTION

The present invention meets this need by providing processes which meet CO₂ product specifications without costly and large pretreatment units. The processes efficiently handle contaminants with minimal or no pretreatment. In some processes, an optional quench column, which may be beneficial for the compressors, removes any HCl and HF in the feed stream. A neutralizing agent can also be added to the circulating fluid in the scrubber to capture SO₂ and reduce the capture requirements downstream. Where high levels of SO₃ are present, it may be removed via various techniques, such as dry sorbent injection. Where high levels of particulates are present, they may be removed via a baghouse, ESP, cartridge filter, or other technologies. The feed gas stream is compressed and may sent to a mercury guard bed where mercury is removed and optionally hydrocarbons may be removed. The gas then goes to the CO₂ pressure swing adsorption (PSA) unit, where activated alumina, or silica gel, or activated carbon, or a combination thereof concentrates CO₂, along with heavy nitrogen oxide compounds, or sulfur oxide compounds, or combinations thereof, and ammonia. Heavy nitrogen oxide compounds are nitrogen oxide compounds with a boiling point higher than that of NO, and include, but are not limited to, NO₂, N₂O₄, N₂O₃. Heavy nitrogen oxide compounds may be in the feed, may be produced from the reaction of NO and O₂, or may form from reactions with other heavy nitrogen oxide compounds. Sulfur oxide compounds include, but are not limited to, SO₂. Optionally, the CO₂ PSA may be a vacuum PSA. The concentrated gas goes to a dehydration unit, such as molecular sieve or a triethylene glycol unit. A molecular sieve may be used to ensure that NH₃ is removed from the stream. The NH₃ in the regeneration gas may be recycled back to the kiln in a cement plant or disposed of in the acidic wastewater. The molecular sieve may be regenerated using product CO₂ or a CO₂ rich dry gas. The CO₂ then goes to an NO₂/SO₂ removal section, which removes heavy nitrogen oxide compounds, and/or sulfur oxide compounds. The heavy nitrogen oxide compounds, and/or sulfur oxide compounds may be sent to atmosphere, absorbed into water to form an acid product, or neutralized. The cryogenic CO₂ fractionation column then completes the separation of CO₂.

An alternative to the NO₂/SO₂ removal section is a water wash column upstream of the dehydration unit to remove heavy nitrogen oxide compounds, and/or sulfur oxide compounds.

The NO₂/SO₂ removal section and the water wash column can be used together to further enhance removal of the heavy nitrogen oxide compounds, and/or the sulfur oxide compounds, if desired.

The integrated contaminant removal and CO₂ PSA/cryogenic CO₂ fractionation column process for flue gas carbon capture allows capture of the CO₂ in the flue gas with low power consumption and meets the CO₂ product specifications for NO₂ and SO₂.

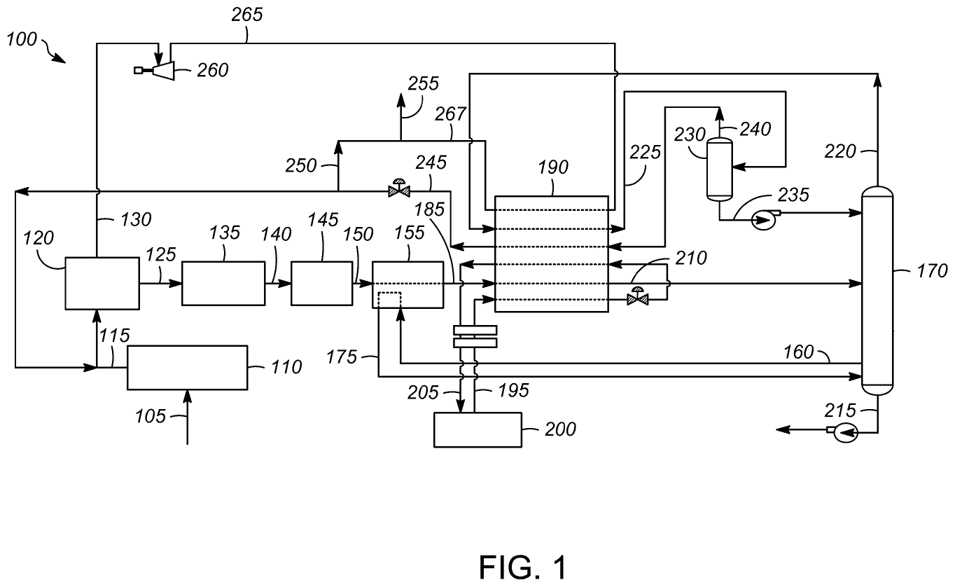

FIG. 1 illustrates a typical process 100 for the recovery of carbon dioxide from a flue gas stream in which the CO₂ fractionation column comes after the CO₂ PSA unit. There is no NO₂ or SO₂ removal and limited heat integration. The flue gas feed stream 105 comprises nitrogen, oxygen, carbon dioxide and at least one of a heavy nitrogen oxide compound, water a sulfur oxide compound, and ammonia. The flue gas feed stream 105 is sent to a flue gas compressor 110 where it is compressed from a pressure in a range of 75 to 150 kPa to a pressure in the range of 600 to 3100 kPa.

The compressed flue gas stream 115 is sent to a CO₂ pressure swing adsorption (PSA) unit which can be a standard CO₂ PSA unit or a CO₂ vacuum pressure swing adsorption (VPSA) unit 120. The compressed flue gas stream 115 is separated into a CO₂-enriched tail gas stream 125 and an off gas stream 130. In some embodiments, the compressed flue gas stream 105 may be sent to a guard bed and/or superheater (not shown) before being sent to the CO₂ PSA unit.

The CO₂-enriched tail gas stream 125 is sent to a tail gas compressor 135 where it is compressed to a pressure in a range of 2300 to 5000 kPa. The compressed tail gas stream 140 is dried in a dehydration unit 145. The dehydration unit 145 may comprise any suitable dehydration unit including, but not limited to, a triethylene glycol unit, an activated alumina or a silica gel or a molecular sieve (zeolite A or X) or a combination thereof-based temperature swing adsorption process.

The dried compressed tail gas stream 150 is passed to column reboiler 155. Reboiler stream 160 from the fractionation column 170 is passed to the column reboiler 155 to chill the dried compressed tail gas stream 150 from 20-50° C. to a temperature in a range of −10° C. to 15° C. The heated reboiler stream 175 is returned to the fractionation column 170. A single reboiler takeoff for this process is typical, however multiple reboilers can be used as seen in the other figures.

Chilled stream 185 is passed to the main heat exchanger 190. Refrigerant stream 195 from the refrigeration unit 200 is passed to the main heat exchanger 190 to further chill chilled stream 185. The refrigerant stream is flashed and cooled via joule-thompson cooling before further cooling the fractionation column overhead vapor. The heated refrigerant stream 205 is returned to the refrigeration unit 200.

The chilled stream 210 is passed to fractionation column 170 where it is separated into the carbon dioxide-enriched product stream 215 and overhead gas stream 220. The overhead gas stream 220 is passed to the main heat exchanger 190 where it is chilled. The chilled overhead stream 225 is passed to accumulator 230 where it is separated into a liquid CO₂ reflux stream 235 and a second overhead gas stream 240. The liquid CO₂ reflux stream 235 is returned to the fractionation column 170.

The second overhead gas stream 240 is passed to the main heat exchanger 190 where it is heated. The heated second overhead stream 245 is recycled to the CO₂ PSA unit 120. A purge stream 250 may be split from the heated second overhead stream 245.

The off gas stream 130 is expanded in expander 260, and the expanded off gas stream 265 heated in the main heat exchanger 190. The heated expanded off gas stream 267 is combined with the purge stream 250, and the combined stream 255 can be vented to the atmosphere.

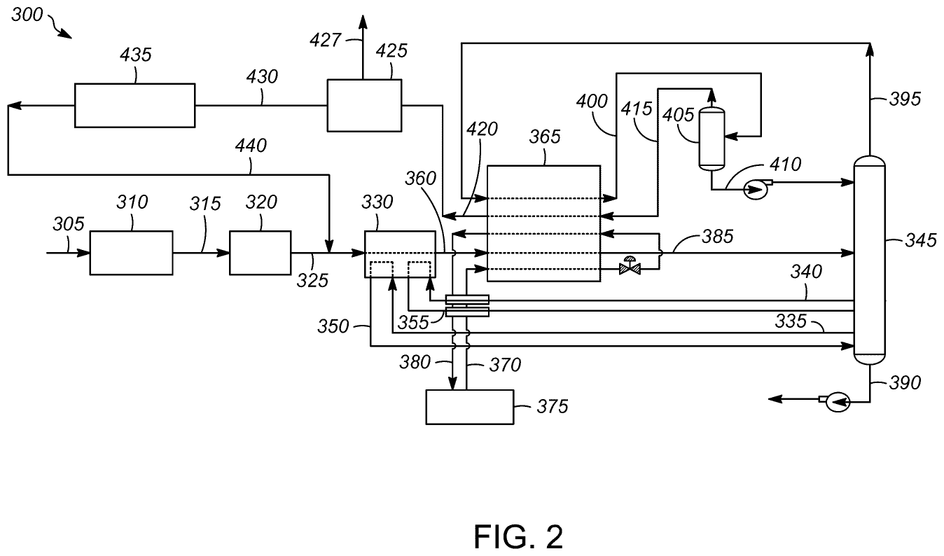

FIG. 2 illustrates another typical process 300 for the recovery of carbon dioxide from a flue gas stream in which the CO₂ fractionation column comes before the CO₂ PSA unit. The flue gas feed stream 305 is sent to a flue gas compressor 310 where it is compressed from a pressure in a range of 75 to 150 kPa to a pressure in the range of 2300 to 5000 kPa.

The compressed flue gas stream 315 is dried in a dehydration unit 320. The dried compressed tail gas stream 325 is passed to column reboiler 330. First side reboiler stream 335 and second side reboiler stream 340 from the fractionation column 345 are passed to the column reboiler 330 to chill the dried compressed tail gas stream 325 from 20-50° C. to a temperature in a range of −10° C. to 15° C. The heated first side reboiler stream 350 and heated second side reboiler stream 355 are returned to the fractionation column 345.

Chilled stream 360 is passed to the main heat exchanger 365. Refrigerant stream 370 from the refrigeration unit 375 is passed to the main heat exchanger 365 to further chill chilled stream 360. The refrigerant stream is flashed and cooled via joule-thompson cooling before further cooling the fractionation column overhead vapor. The heated refrigerant stream 380 is returned to the refrigeration unit 375.

The chilled stream 385 is passed to fractionation column 345 where it is separated into the carbon dioxide-enriched product stream 390 and overhead gas stream 395. The overhead gas stream 395 is passed to the main heat exchanger 365 where it is chilled. The chilled overhead stream 400 is passed to accumulator 405 where it is separated into a liquid CO₂ reflux stream 410 and a second overhead gas stream 415. The liquid CO₂ reflux stream 410 is returned to the fractionation column 345.

The second overhead gas stream 415 is passed to the main heat exchanger 365 where it is heated. The heated second overhead stream 420 is sent to CO₂ PSA unit 425 where it is separated into a CO₂-enriched tail gas stream 430 and a CO₂ lean off gas stream 427. The CO₂ lean off gas stream 427 can be vented to the atmosphere.

The CO₂-enriched tail gas stream 430 is sent to a tail gas compressor 435 where it is compressed to a pressure in a range of 2300 to 5000 kPa. The compressed tail gas stream 440 is sent to the column reboiler 330. Or stream 430 can be combined with the flue gas feed stream 305 and the combined stream can be compressed with the flue gas compressor 310.

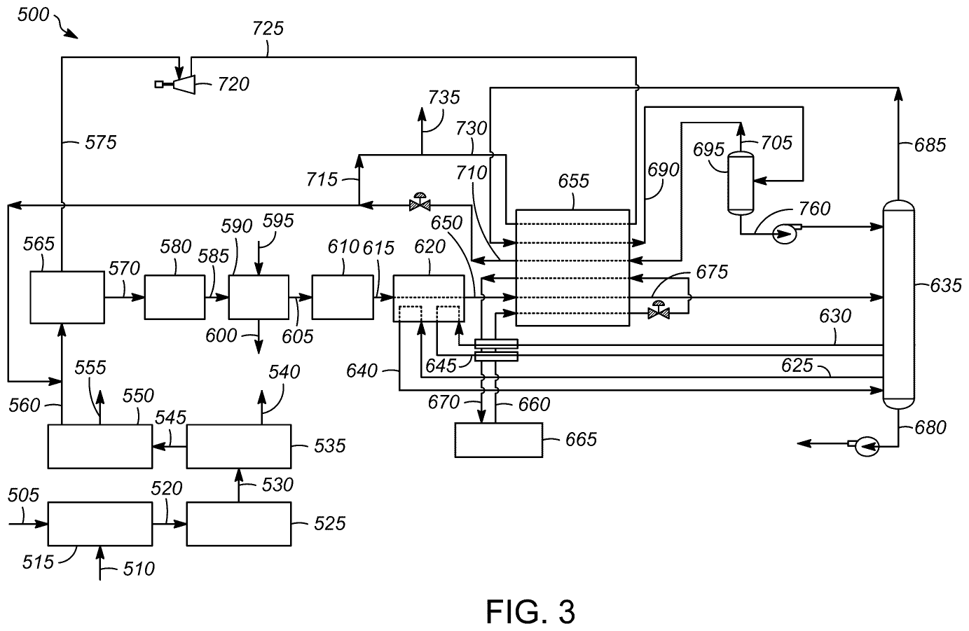

FIG. 3 illustrates a process 500 for the recovery of carbon dioxide from a flue gas stream using a water wash unit and upstream pretreatment.

The flue gas feed stream 505 comprises carbon dioxide and at least one of a heavy nitrogen oxide compound, a sulfur oxide compound, and ammonia. The flue gas feed stream 505 and a water stream 510 are sent to an optional quench column or scrubber 515 to cool the flue gas feed stream and to remove HCl and HF. The water stream 510 may include a neutralizing agent, including but not limited to caustic, lime, or combinations thereof. When the neutralizing agent is included, SO₂ may also be recovered. Dry sorbent injection may also be used to reduce the concentration of SO₃ and/or mercury, and additional particulate filtration may be added to reduce the concentration of particulates to the downstream compressors.

The quenched flue gas stream 520 from the optional quench column or scrubber 515 is sent to the flue gas compressor 525 where it is compressed from a pressure in a range of 75 to 150 kPa to a pressure in the range of 600 to 3100 kPa.

The compressed flue gas stream 530 is sent to an optional guard bed 535 to remove one or more of Hg(0), Hg(2+), heavy metals, hydrocarbons, NO₂, and SO₂ in waste stream 540. Suitable guard beds include, but are not limited to, carbon guard beds, zeolite-based guard beds, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 545 from the optional guard bed 535 is sent to an optional particulate polishing unit 550 where a particulate stream 555 is removed. Suitable particulate polishing units include, but are not limited to, a cartridge filter, a baghouse, and the like.

The effluent 560 from the optional particulate polishing unit 550 is sent to a CO₂ pressure swing adsorption (PSA) unit 565, which can be a standard CO₂ PSA unit or a CO₂ vacuum pressure swing adsorption (VPSA) unit. The effluent 560 is separated into a CO₂-enriched tail gas stream 570 and an off gas stream 575.

The CO₂-enriched tail gas stream 570 is sent to a tail gas compressor 580 where it is compressed to a pressure in a range of 2300 to 5000 kPa. The compressed tail gas stream 585 is sent to a water wash unit 590. A stream of water 595 is added to the water wash unit 590 to remove heavy nitrogen oxide compounds, or sulfur oxide compounds, or combinations thereof by forming dilute nitric acid, nitrous acid, and/or sulfuric acid in purge stream 600.

The water washed compressed tail gas stream 605 is dried in a dehydration unit 610. Suitable dehydration units include, but are not limited to, a triethylene glycol unit, an activated alumina, or a silica gel, or a molecular sieve (zeolite A or X), or a combination thereof-based temperature swing adsorption process and the like.

The dried compressed tail gas stream 615 is passed to column reboiler 620. First side reboiler stream 625 and second side reboiler stream 630 from the CO₂ fractionation column 635 are passed to the column reboiler 620 to chill the dried compressed tail gas stream 615 from 20-50° C. to a temperature in a range of −10° C. to 15° C. The heated first side reboiler stream 640 and heated second side reboiler stream 645 are returned to the CO₂ fractionation column 635.

Chilled stream 650 is passed to the main heat exchanger 655. Refrigerant stream 660 from the refrigeration unit 665 is passed to the main heat exchanger 655 to further chill chilled stream 650. The refrigerant stream is flashed and cooled via joule-thompson cooling before further cooling the fractionation column overhead vapor. The heated refrigerant stream 670 is returned to the refrigeration unit 665.

The chilled stream 675 is passed to CO₂ fractionation column 635 where it is separated into the carbon dioxide-enriched product stream 680 and overhead gas stream 685. The overhead gas stream 685 is passed to the main heat exchanger 655 where it is chilled. The chilled overhead stream 690 is passed to accumulator 695 where it is separated into a liquid CO₂ reflux stream 700 and a second overhead gas stream 705. The liquid CO₂ reflux stream 700 is returned to the fractionation column 635.

The second overhead gas stream 705 is passed to the main heat exchanger 655 where it is heated. The heated second overhead stream 710 is recycled to the CO₂ PSA unit 565. A purge stream 715 may be split from the heated second overhead stream 710.

The off gas stream 575 is expanded in expander 720, and the expanded off gas stream 725 heated in the main heat exchanger 655. The heated expanded off gas stream 730 is combined with the purge stream 715, and the combined stream 735 can be vented to the atmosphere.

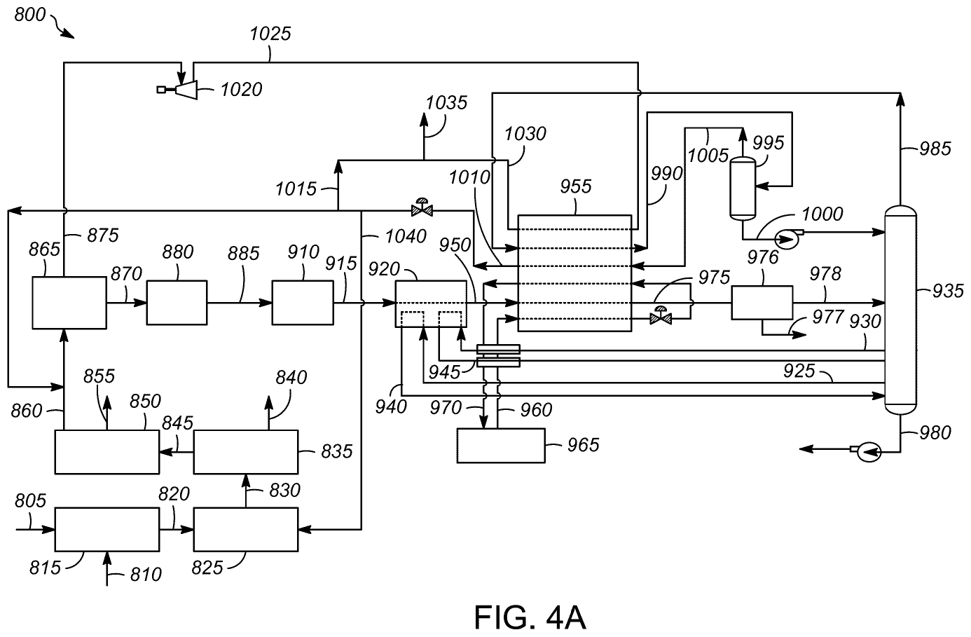

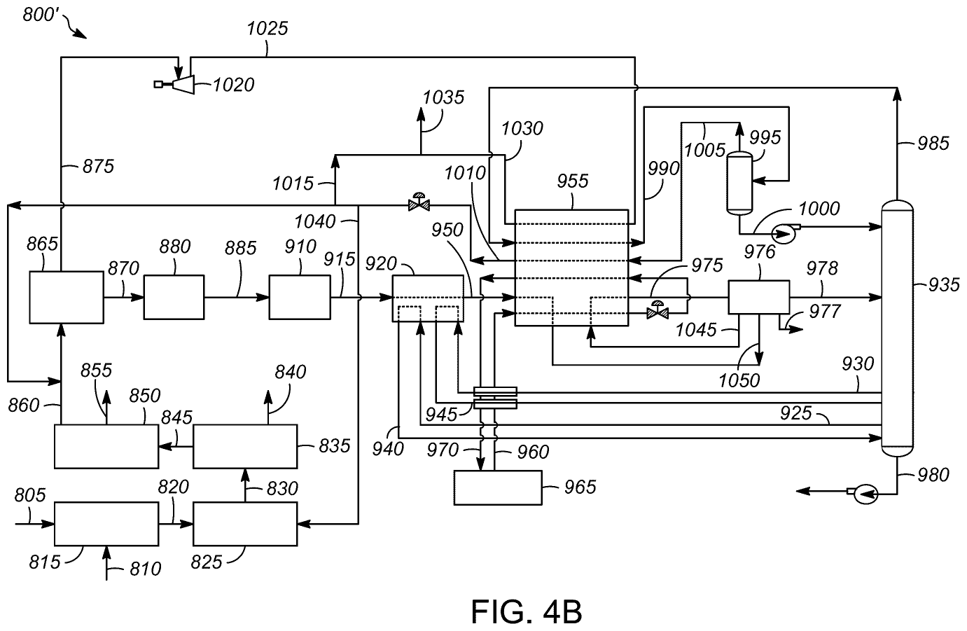

FIG. 4A illustrates a process 800 for the recovery of carbon dioxide from a flue gas stream using an NO₂—SO₂ fractionation column with a single cooling stage.

The flue gas feed stream 805 comprises carbon dioxide and at least one of a heavy nitrogen oxide compound, a sulfur oxide compound, and ammonia. The flue gas feed stream 805 and a water stream 810 are sent to an optional quench column or scrubber 815 to cool the flue gas feed stream and to remove HCl and HF. The water stream 810 may include a neutralizing agent. When the neutralizing agent is included, SO₂ may also be recovered. Dry sorbent injection may also be used to reduce the concentration of SO₃ and/or mercury, and additional particulate filtration may be added to reduce the concentration of particulates to the downstream compressors.

The quenched flue gas stream 820 from the optional quench column or scrubber 815 is sent to the flue gas compressor 825 where it is compressed from a pressure in a range of 75 to 150 kPa to a pressure in the range of 600 to 3100 kPa.

The compressed flue gas stream 830 is sent to an optional guard bed 835 to remove one or more of Hg(0), Hg(2+), hydrocarbons, NO₂, and SO₂ in waste stream 840. Suitable guard beds include, but are not limited to carbon guard beds, zeolite-based guard bed, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 845 from the optional guard bed 835 is sent to an optional particulate polishing unit 850 where a particulate stream 855 is removed. Suitable particulate polishing units include, but are not limited to, a cartridge filter, a baghouse, and the like.

The effluent 860 from the optional particulate polishing unit 850 is sent to a CO₂ pressure swing adsorption (PSA) unit 865, which can be a standard CO₂ PSA unit or a CO₂ vacuum pressure swing adsorption (VPSA) unit. The effluent 860 is separated into a CO₂-enriched tail gas stream 870 and an off gas stream 875.

The CO₂-enriched tail gas stream 870 is sent to a tail gas compressor 880 where it is compressed to a pressure in a range of 2300 to 5000 kPa.

The compressed tail gas stream 885 is dried in a dehydration unit 910. Suitable dehydration units include, but are not limited to, a triethylene glycol unit, an activated alumina or a silica gel or a molecular sieve (zeolite A or X) or a combination thereof-based temperature swing adsorption process and the like.

The dried compressed tail gas stream 915 is passed to column reboiler 920. First side reboiler stream 925 and second side reboiler stream 930 from the CO₂ fractionation column 935 are passed to the column reboiler 920 to chill the dried compressed tail gas stream 915 from 20-50° C. to a temperature in a range of −10° C. to 15° C. The heated first side reboiler stream 940 and heated second side reboiler stream 945 are returned to the CO₂ fractionation column 935.

Chilled stream 950 is passed to the main heat exchanger 955. Refrigerant stream 960 from the refrigeration unit 965 is passed to the main heat exchanger 955 to further chill chilled stream 950. The refrigerant stream is flashed and cooled via joule-thompson cooling before further cooling the fractionation column overhead vapor. The heated refrigerant stream 970 is returned to the refrigeration unit 965.

The chilled stream 975 is passed to a NO₂/SO₂ removal section 976 where liquid stream 977 containing the heavy nitrogen oxide compounds, and/or the sulfur oxide compounds are removed.

The gas stream 978 from the NO₂/SO₂ removal section 976 is sent to the CO₂ fractionation column 935 where it is separated into the carbon dioxide-enriched product stream 980 and overhead gas stream 985. The overhead gas stream 985 is passed to the main heat exchanger 955 where it is chilled. The chilled overhead stream 990 is passed to accumulator 995 where it is separated into a liquid CO₂ reflux stream 1000 and a second overhead gas stream 1005. The liquid CO₂ reflux stream 1000 is returned to the fractionation column 935.

The second overhead gas stream 1005 is passed to the main heat exchanger 955 where it is heated. The heated second overhead stream 1010 is recycled to the CO₂ PSA unit 865. A purge stream 1015 may be split from the heated second overhead stream 1010.

The off gas stream 875 is expanded in expander 1020, and the expanded off gas stream 1025 heated in the main heat exchanger 955. The heated expanded off gas stream 1030 is combined with the purge stream 1015, and the combined stream 1035 can be vented to the atmosphere.

Another portion 1040 of the heated second overhead stream 1010 may be sent to the flue gas compressor 825.

FIG. 4B illustrates a process 800′ for the recovery of carbon dioxide from a flue gas stream using an NO₂—SO₂ fractionation column with a dual cooling stage.

The flue gas feed stream 805 comprises carbon dioxide and at least one of a heavy nitrogen oxide compound, a sulfur oxide compound, and ammonia. The flue gas feed stream 805 and a water stream 810 are sent to an optional quench column or scrubber 815 to cool the flue gas feed stream and to remove HCl and HF. The water stream 810 may include a neutralizing agent. When the neutralizing agent is included, SO₂ may also be recovered. Dry sorbent injection may also be used to reduce the concentration of SO₃ and/or mercury, and additional particulate filtration may be added to reduce the concentration of particulates to the downstream compressors.

The quenched flue gas stream 820 from the optional quench column or scrubber 815 is sent to the flue gas compressor 825 where it is compressed from a pressure in a range of 75 to 150 kPa to a pressure in the range of 600 to 3100 kPa.

The compressed flue gas stream 830 is sent to an optional guard bed 835 to remove one or more of Hg(0), Hg(2+), heavy metals, hydrocarbons, NO₂, and SO₂ in waste stream 840. Suitable guard beds include, but are not limited to, carbon guard beds, zeolite-based guard beds, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 845 from the optional guard bed 835 is sent to an optional particulate polishing unit 850 where a particulate stream 855 is removed. Suitable particulate polishing units include, but are not limited to, a cartridge filter, a baghouse, and the like.

The effluent 860 from the optional particulate polishing unit 850 is sent to a CO₂ pressure swing adsorption (PSA) unit 865, which can be a standard CO₂ PSA unit or a CO₂ vacuum pressure swing adsorption (VPSA) unit. The effluent 860 is separated into a CO₂-enriched tail gas stream 870 and an off gas stream 875.

The CO₂-enriched tail gas stream 870 is sent to a tail gas compressor 880 where it is compressed to a pressure in a range of 2300 to 5000 kPa.

The compressed tail gas stream 885 is dried in a dehydration unit 910. Suitable

dehydration units include, but are not limited to, a triethylene glycol unit, an activated alumina or a silica gel or a molecular sieve (zeolite A or X) or a combination thereof-based temperature swing adsorption process and the like.

The dried compressed tail gas stream 915 is passed to column reboiler 920. First side reboiler stream 925 and second side reboiler stream 930 from the CO₂ fractionation column 935 are passed to the column reboiler 920 to chill the dried compressed tail gas stream 915 from 20-50° C. to a temperature in a range of −10° C. to 15° C. The heated first side reboiler stream 940 and heated second side reboiler stream 945 are returned to the CO₂ fractionation column 935.

Chilled stream 950 is passed to the main heat exchanger 955. Refrigerant stream 960 from the refrigeration unit 965 is passed to the main heat exchanger 955 to further chill chilled stream 950. The refrigerant stream is flashed and cooled via joule-thompson cooling before further cooling the fractionation column overhead vapor. The heated refrigerant stream 970 is returned to the refrigeration unit 965.

The chilled stream 975 is passed to a NO₂/SO₂ removal section 976 where is liquid stream 977 containing the heavy nitrogen oxide compounds and/or the sulfur oxide compounds are removed. Stream 1050 from the NO₂/SO₂ removal section 976 is sent to the main heat exchanger where it is cooler prior to the first separator. The condensed material is separated, and the gas is further chilled in the main heat exchanger to form stream 1045. This stream is separated in the second separator, and the condensate is combined with the liquid from the first separator. The total condensate is sent to a column where the heavy nitrogen oxide compounds and/or the sulfur oxide compounds are concentrated in the bottoms product, and the vapor, which is lean in heavy nitrogen oxide compounds and/or the sulfur oxide compounds, is recombined with the vapor from the second separator.

The vapor stream 978 from the NO₂/SO₂ removal section 976 is sent to the CO₂ fractionation column 935 where it is separated into the carbon dioxide-enriched product stream 980 and overhead gas stream 985. The overhead vapor stream 985 is passed to the main heat exchanger 955 where it is chilled. The chilled overhead stream 990 is passed to accumulator 995 where it is separated into a liquid CO₂ reflux stream 1000 and a second overhead gas stream 1005. The liquid CO₂ reflux stream 1000 is returned to the fractionation column 935.

The second overhead gas stream 1005 is passed to the main heat exchanger 955 where it is heated. The heated second overhead stream 1010 is recycled to the CO₂ PSA unit 865. A purge stream 1015 may be split from the heated second overhead stream 1010.

The off gas stream 875 is expanded in expander 1020, and the expanded off gas stream 1025 heated in the main heat exchanger 955. The heated expanded off gas stream 1030 is combined with the purge stream 1015, and the combined stream 1035 can be vented to the atmosphere.

Another portion 1040 of the heated second overhead stream 1010 may be sent to the flue gas compressor 825.

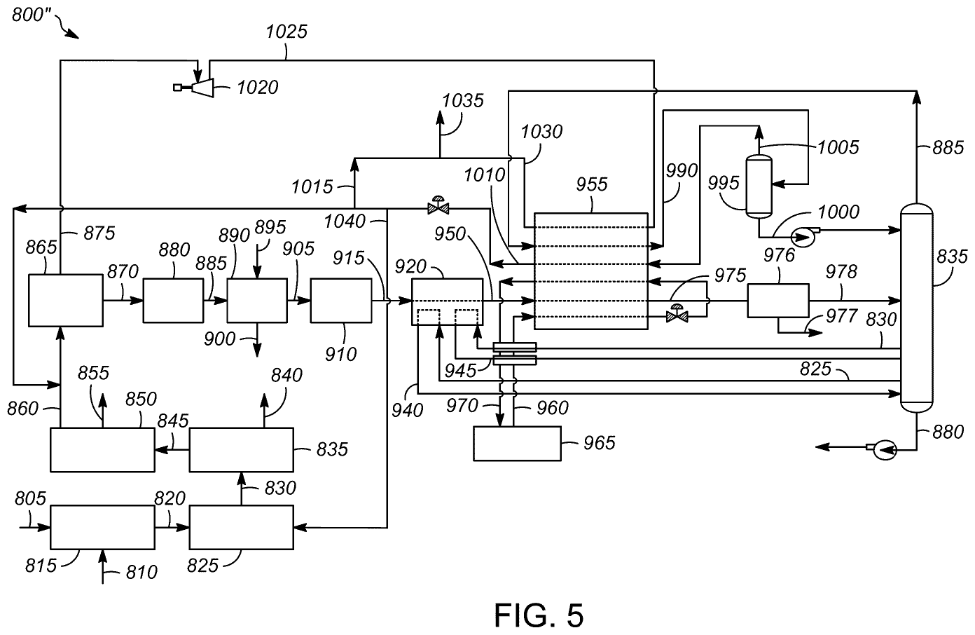

FIG. 5 illustrates a process 800″ for the recovery of carbon dioxide from a flue gas stream using a water wash unit and an NO₂—SO₂ fractionation column with a single cooling stage.

The flue gas feed stream 805 comprises carbon dioxide and at least one of a heavy nitrogen oxide compound, a sulfur oxide compound, and ammonia. The flue gas feed stream 805 and a water stream 810 are sent to an optional quench column or scrubber 815 to cool the flue gas feed stream and to remove HCl and HF. The water stream 810 may include a neutralizing agent. When the neutralizing agent is included, SO₂ may also be recovered. Dry Sorbent injection may also be used to reduce the concentration of SO₃ and/or mercury, and additional particulate filtration may be added to reduce the concentration of particulates to the downstream compressors.

The quenched flue gas stream 820 from the optional quench column or scrubber 815 is sent to the flue gas compressor 825 where it is compressed from a pressure in a range of 75 to 150 kPa to a pressure in the range of 600 to 3100 kPa.

The compressed flue gas stream 830 is sent to an optional guard bed 835 to remove one or more of Hg(0), Hg(2+), hydrocarbons, heavy nitrogen oxide compounds and/or the sulfur oxide compounds in waste stream 840. Suitable guard beds include, carbon guard beds, zeolite-based guard bed, including sacrificial or regenerative guard beds, and the like.

The effluent stream 845 from the optional guard bed 835 is sent to an optional particulate polishing unit 850 where a particulate stream 855 is removed. Suitable particulate polishing units include, but are not limited to, a cartridge filter, a baghouse, and the like.

The effluent 860 from the optional particulate polishing unit 850 is sent to a CO₂ pressure swing adsorption (PSA) unit 865, which can be a standard CO₂ PSA unit or a CO₂ vacuum pressure swing adsorption (VPSA) unit. The effluent 860 is separated into a CO₂-enriched tail gas stream 870 and an off gas stream 875.

The CO₂-enriched tail gas stream 870 is sent to a tail gas compressor 880 where it is compressed to a pressure in a range of 2300 to 5000 kPa. The compressed tail gas stream 885 sent to a water wash unit 890. A stream of water 895 is added to the water wash unit 890 to remove NO₂ and SO₂ by forming dilute nitric acid, nitrous acid, and/or sulfuric acid in purge stream 900.

The water washed compressed tail gas stream 905 is dried in a dehydration unit 910. Suitable dehydration units include, but are not limited to, a triethylene glycol unit, an activated alumina or a silica gel or a molecular sieve (zeolite A or X) or a combination thereof-based temperature swing adsorption process and the like.

The dried compressed tail gas stream 915 is passed to column reboiler 920. First side reboiler stream 825 and second side reboiler stream 830 from the CO₂ fractionation column 835 are passed to the column reboiler 920 to chill the dried compressed tail gas stream 915 from 20-50° C. to a temperature in a range of −10° C. to 15° C. The heated first side reboiler stream 940 and heated second side reboiler stream 945 are returned to the CO₂ fractionation column 835.

Chilled stream 950 is passed to the main heat exchanger 955. Refrigerant stream 960 from the refrigeration unit 965 is passed to the main heat exchanger 955 to further chill chilled stream 950. The refrigerant stream is flashed and cooled via joule-thompson cooling before further cooling the column overhead vapor. The heated refrigerant stream 970 is returned to the refrigeration unit 965.

The chilled stream 975 is passed to a NO₂/SO₂ removal section 976 where a liquid stream 977 containing the heavy nitrogen oxide compounds and/or the sulfur oxide compounds are removed.

The gas stream 978 from the NO₂/SO₂ removal section 976 is sent to the CO₂ fractionation column 835 where it is separated into the carbon dioxide-enriched product stream 880 and overhead gas stream 885. The overhead gas stream 885 is passed to the main heat exchanger 955 where it is chilled. The chilled overhead stream 890 is passed to accumulator 995 where it is separated into a liquid CO₂ reflux stream 1000 and a second overhead gas stream 1005. The liquid CO₂ reflux stream 1000 is returned to the fractionation column 935.

The second overhead gas stream 1005 is passed to the main heat exchanger 955 where it is heated. The heated second overhead stream 1010 is recycled to the CO₂ PSA unit 865. A purge stream 1015 may be split from the heated second overhead stream 1010.

The off gas stream 875 is expanded in expander 1020, and the expanded off gas stream 1025 heated in the main heat exchanger 955. The heated expanded off gas stream 1030 is combined with the purge stream 1015, and the combined stream 1035 can be vented to the atmosphere.

Another portion 1040 of the heated second overhead stream 1010 may be sent to the flue gas compressor 825.

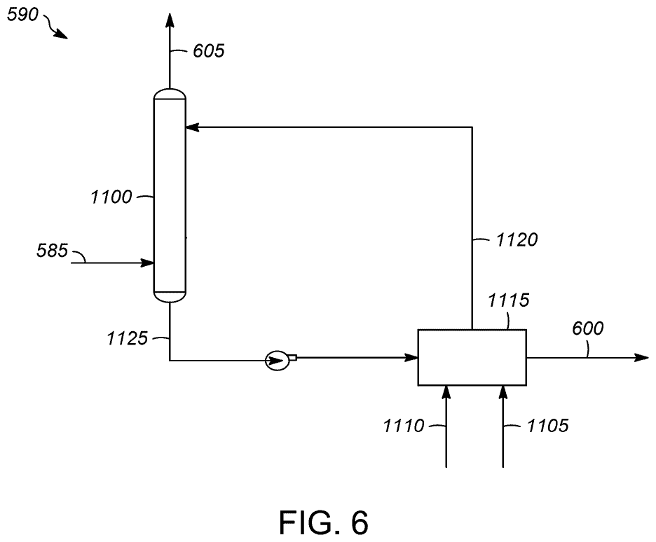

FIG. 6 illustrates one embodiment of a water wash unit 590. The compressed tail gas stream 585 is sent to a water wash column 1100. Water stream 1105 and optional neutralizing agent treatment stream 1110 are sent to the water treatment unit 1115. The treated water 1120 is sent to the water wash column 1100 for countercurrent flow with the compressed tail gas stream 585 to remove the heavy nitrogen oxide compounds and/or the sulfur oxide compounds. The bottom stream 1125 from the water wash column 1100 is sent to the water treatment unit 1115. The nitric acid, nitrous acid, and sulfuric acid that are formed may be neutralized and removed from water treatment unit 1115 in the purge stream 600.

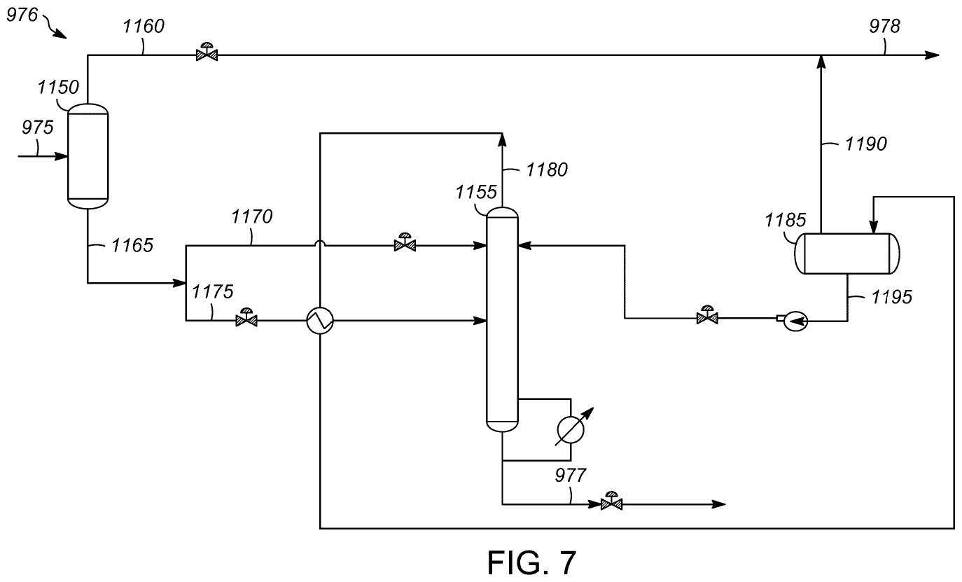

FIG. 7 illustrates one embodiment of a NO₂/SO₂ removal zone 976 with a single cooling stage. The NO₂/SO₂ removal zone 976 comprises a gas-liquid separator 1150 and an NO₂—SO₂ fractionation column 1155. The chilled stream 975 is sent to the gas-liquid separator 1150 where it is separated into a separator overhead stream 1160 and a separator liquid bottom stream 1165. The separator liquid bottom stream 1165 is split into first liquid stream 1170 and second liquid stream 1175. The first and second liquid streams 1170, 1175 are introduced into the NO₂—SO₂ fractionation column 1155 at different points on the NO₂—SO₂ fractionation column 1155 where they are separated into an NO₂—SO₂ fractionation column overhead stream 1180 and liquid stream 977 containing the heavy nitrogen oxide compounds and/or the sulfur oxide compounds which is sent for treatment or vented to the atmosphere.

The NO₂—SO₂ fractionation column overhead stream 1180 is heat exchanged with the second liquid stream 1175 and sent to an overhead receiver 1185 where it is separated into receiver overhead gas stream 1190 and receiver liquid stream 1195. Receiver liquid stream 1195 is refluxed to the NO₂—SO₂ fractionation column 1155. The receiver overhead gas stream 1190 and the separator overhead gas stream 1160 are combined as gas stream 978 and sent to the CO₂ fractionation column 935.

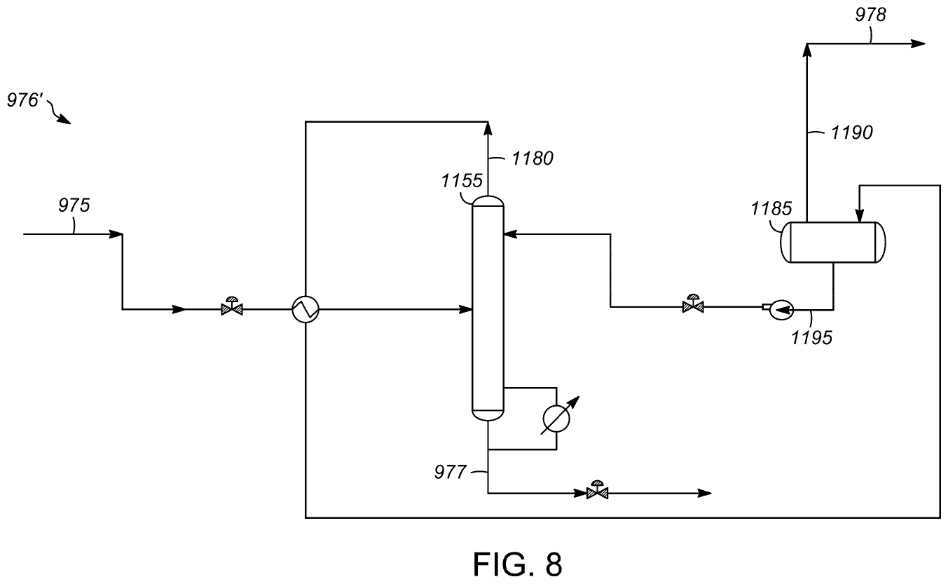

FIG. 8 illustrates a second embodiment of a NO₂/SO₂ removal zone 976′ with a single cooling stage. The NO₂/SO₂ removal zone 976′ comprises an NO₂—SO₂ fractionation column 1155. The chilled stream 975 is sent to the to the NO₂—SO₂ fractionation column 1155 where it is separated into an NO₂—SO₂ fractionation column overhead stream 1180 and liquid stream 977 containing the heavy nitrogen oxide compounds and/or the sulfur oxide compounds which is sent for treatment or vented to the atmosphere.

The NO₂—SO₂ fractionation column overhead stream 1180 is heat exchanged with the chilled stream 975 and sent to an overhead receiver 1185 where it is separated into receiver overhead gas stream 1190 and receiver liquid stream 1195. Receiver liquid stream 1195 is refluxed to the NO₂—SO₂ fractionation column 1155. The receiver overhead gas stream 1190 is gas stream 978 which is sent to the CO₂ fractionation column 935.

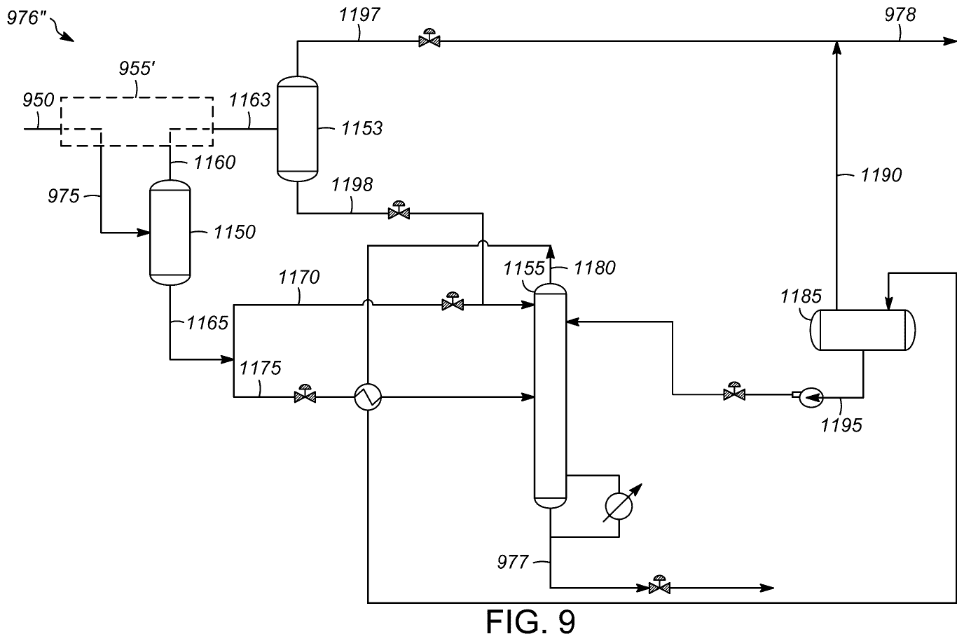

FIG. 9 illustrates one embodiment of a NO₂/SO₂ removal zone 976 with dual cooling stages. The NO₂/SO₂ removal section 976 comprises first and second gas-liquid separators 1150, 1153 and an NO₂—SO₂ fractionation column 1155. The chilled stream 950 is sent to the main heat exchanger 955. The chilled stream 975 from the main heat exchanger 955 is sent the first gas-liquid separator 1150 where it is separated into a first separator overhead stream 1160 and a first separator liquid bottom stream 1165. The first separator liquid bottom stream 1165 is split into first liquid stream 1170 and second liquid stream 1175. The first and second liquid streams 1170, 1175 are introduced into the NO₂—SO₂ fractionation column 1155 at different points on the NO₂—SO₂ fractionation column 1155 where they are separated into an NO₂—SO₂ fractionation column overhead stream 1180 and liquid stream 977 containing the heavy nitrogen oxide compounds and/or the sulfur oxide compounds which is sent for treatment or vented to the atmosphere.

The NO₂—SO₂ fractionation column overhead stream 1180 is heat exchanged with the second liquid stream 1175 and sent to an overhead receiver 1185 where it is separated into receiver overhead gas stream 1190 and receiver liquid stream 1195. Receiver liquid stream 1195 is refluxed to the NO₂—SO₂ fractionation column 1155.

The first separator overhead stream 1160 is sent to the main heat exchanger 955 where it is cooled, and the cooled stream 1163 is sent to the second separator 1153 where it is separated into second separator overhead gas stream 1197 and second separator liquid bottom stream 1198. The second separator liquid bottom stream 1198 is combined with the first liquid stream 1170 and sent to the NO₂—SO₂ fractionation column 1155.

The receiver overhead gas stream 1190 and the second separator overhead gas stream 1197 are combined as gas stream 978 and sent to the CO₂ fractionation column 935.

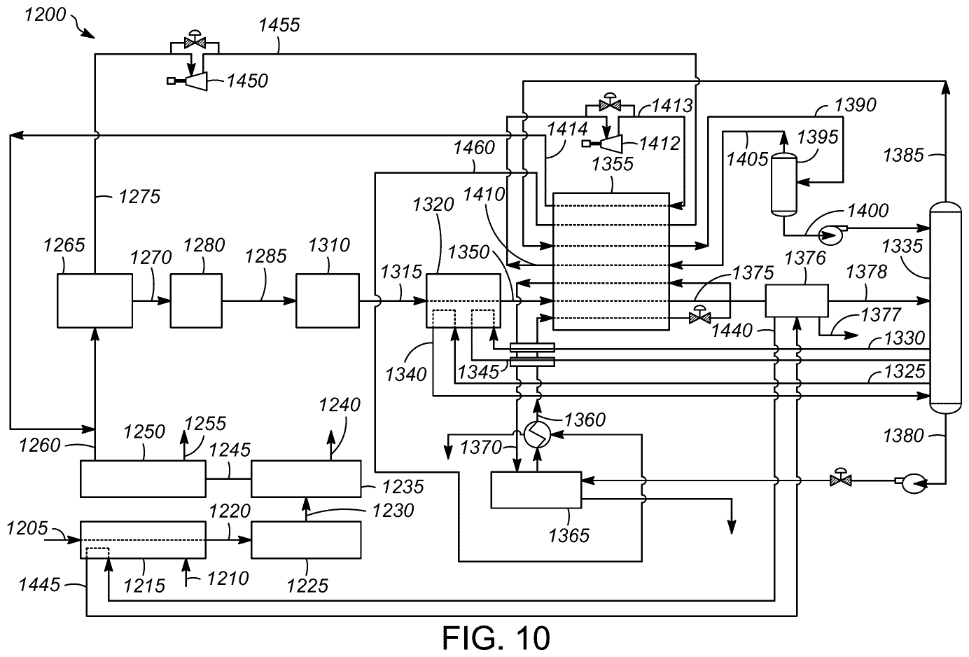

FIG. 10 illustrates an integrated process 1200 for the recovery of carbon dioxide from a flue gas stream using an NO₂—SO₂ removal section with an NO₂—SO₂ fractionation column with a dual cooling stage.

The flue gas feed stream 1205 comprises carbon dioxide and at least one of a nitrogen oxide compound, a sulfur oxide compound, and ammonia. The flue gas feed stream 1205 and a water stream 1210 are sent to an optional quench column or scrubber 1215 to cool the flue gas feed stream and to remove HCl and HF. The water stream 1210 may include a neutralizing agent. When the neutralizing agent is included, SO₂ may also be recovered. Dry sorbent injection may also be used to reduce the concentration of SO₃ and/or mercury, and additional particulate filtration may be added to reduce the concentration of particulates to the downstream compressors.

The quenched flue gas stream 1220 from the optional quench column or scrubber 1215 is sent to the flue gas compressor 1225 where it is compressed from a pressure in a range of 75 to 150 kPa to a pressure in the range of 600 to 3100 kPa.

The compressed flue gas stream 1230 is sent to an optional guard bed 1235 to remove one or more of Hg(0), Hg(2+), heavy metals, hydrocarbons, heavy nitrogen oxide compounds and/or sulfur oxide compounds in waste stream 1240. Suitable guard beds include, carbon guard beds, zeolite-based guard bed, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 1245 from the optional guard bed 1235 is sent to an optional particulate polishing unit 1250 where a particulate stream 1255 is removed. Suitable particulate polishing units include, but are not limited to, a cartridge filter, a baghouse, and the like.

The effluent 1260 from the optional particulate polishing unit 1250 is sent to a CO₂ PSA unit 1265, which can be a standard CO₂ PSA unit or a CO₂ vacuum pressure swing adsorption (VPSA) unit. The effluent 1260 is separated into a CO₂-enriched tail gas stream 1270 and an off gas stream 1275.

The CO₂-enriched tail gas stream 1270 is sent to a tail gas compressor 1280 where it is compressed to a pressure in a range of 2300 to 5000 kPa.

The compressed tail gas stream 1285 is dried in a dehydration unit 1310. Suitable dehydration units include, but are not limited to, a triethylene glycol unit, an activated alumina or a silica gel or a molecular sieve (zeolite A or X) or a combination thereof-based temperature swing adsorption process and the like.

The dried compressed tail gas stream 1315 is passed to column reboiler 1320. First side reboiler stream 1325 and second side reboiler stream 1330 from the CO₂ fractionation column 1335 are passed to the column reboiler 1320 to chill the dried compressed tail gas stream 1315 from 20-50° C. to a temperature in a range of −10° C. to 15° C. The heated first side reboiler stream 1340 and heated second side reboiler stream 1345 are returned to the CO₂ fractionation column 1335.

Chilled stream 1350 is passed to the main heat exchanger 1355. Refrigerant stream 1360 from the refrigeration unit 1365 is passed to the main heat exchanger 1355 to further chill chilled stream 1350. The refrigerant stream is flashed and cooled via joule-thompson cooling before further cooling the fractionation column overhead vapor. The heated refrigerant stream 1370 is returned to the refrigeration unit 1365.

The chilled stream 1375 is passed to a NO₂/SO₂ removal section 1376 where liquid stream 1377 containing the heavy nitrogen oxide compounds and/or the sulfur oxide compounds is removed. Reboiler inlet stream 1445 from the NO₂/SO₂ removal section 1376 is sent to the quench column section 1215 where warm circulating water is used to partially vaporize the stream. The partially vaporized stream 1440 is then returned to the NO₂/SO₂ removal section 1376.

The gas stream 1378 from the NO₂/SO₂ removal section 1376 is sent to the CO₂ fractionation column 1335 where it is separated into the carbon dioxide-enriched product stream 1380 and overhead gas stream 1385. The overhead gas stream 1385 is passed to the main heat exchanger 1355 where it is chilled. The chilled overhead stream 1390 is passed to accumulator 1395 where it is separated into a liquid CO₂ reflux stream 1400 and a second overhead gas stream 1405. The liquid CO₂ reflux stream 1400 is returned to the fractionation column 1335.

The second overhead gas stream 1405 is passed to the main heat exchanger 1355 where it is heated. The heated second overhead stream 1410 is expanded in expander 1412, heated in the main heat exchanger 1355, and the heated expanded second overhead stream 1414 is recycled to the CO₂ PSA unit 1265.

The off gas stream 1275 is expanded in off gas expander 1450, and the expanded off gas stream 1455 is heated in main heat exchanger 1355. The heated expanded off gas stream 1460 is heat exchanged with the compressed refrigerant stream 1360 and vented to the atmosphere.

CO₂-enriched product stream 1380 is heated and vaporized in refrigeration unit 1365 to provide additional cooling to the refrigerant.

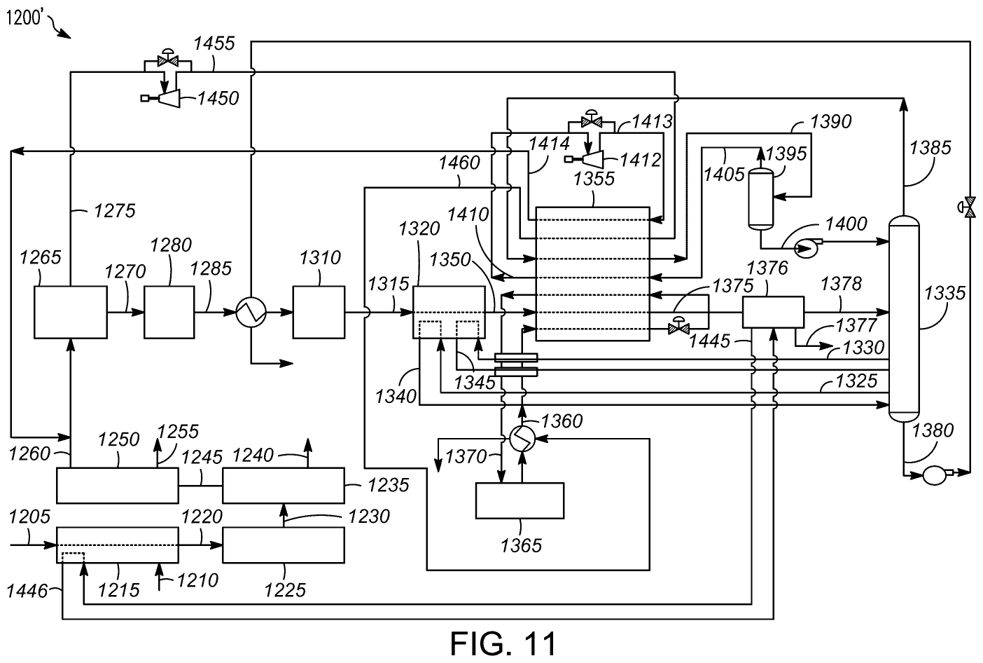

FIG. 11 illustrates another integrated process 1200′ for the recovery of carbon dioxide from a flue gas stream using an NO₂—SO₂ fractionation column with a dual cooling stage.

The flue gas feed stream 1205 comprises carbon dioxide and at least one of a heavy nitrogen oxide compound, a sulfur oxide compound, and ammonia. The flue gas feed stream 1205 and a water stream 1210 are sent to an optional quench column or scrubber 1215 to cool the flue gas feed stream and to remove HCl and HF. The water stream 1210 may include a neutralizing agent. When the neutralizing agent is included, SO₂ may also be recovered. Dry sorbent injection may also be used to reduce the concentration of SO₃ and/or mercury, and additional particulate filtration may be added to reduce the concentration of particulates to the downstream compressors.

The quenched flue gas stream 1220 from the optional quench column or scrubber 1215 is sent to the flue gas compressor 1225 where it is compressed from a pressure in a range of 75 to 150 kPa to a pressure in the range of 600 to 3100 kPa.

The compressed flue gas stream 1230 is sent to an optional guard bed 1235 to remove one or more of Hg(0), Hg(2+), heavy metals, hydrocarbons, heavy nitrogen oxide compounds and/or sulfur oxide compounds in waste stream 1240. Suitable guard beds include, but are not limited to, carbon guard beds, zeolite-based guard bed, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 1245 from the optional guard bed 1235 is sent to an optional particulate polishing unit 1250 where a particulate stream 1255 is removed. Suitable particulate polishing units include, but are not limited to, a cartridge filter, a baghouse, and the like.

The effluent 1260 from the optional particulate polishing unit 1250 is sent to a CO₂ PSA unit 1265, which can be a standard CO₂ PSA unit or a CO₂ vacuum pressure swing adsorption (VPSA) unit. The effluent 1260 is separated into a CO₂-enriched tail gas stream 1270 and an off gas stream 1275.

The CO₂-enriched tail gas stream 1270 is sent to a tail gas compressor 1280 where it is compressed to a pressure in a range of 2300 to 5000 kPa.

The compressed tail gas stream 1285 is dried in a dehydration unit 1310. Suitable dehydration units include, but are not limited to, a triethylene glycol unit, an activated alumina or a silica gel or a molecular sieve (zeolite A or X) or a combination thereof-based temperature swing adsorption process and the like.

The dried compressed tail gas stream 1315 is passed to column reboiler 1320. First side reboiler stream 1325 and second side reboiler stream 1330 from the CO₂ fractionation column 1335 are passed to the column reboiler 1320 to chill the dried compressed tail gas stream 1315 from 20-50° C. to a temperature in a range of −10° C. to 15° C. The heated first side reboiler stream 1340 and heated second side reboiler stream 1345 are returned to the CO₂ fractionation column 1335.

Chilled stream 1350 is passed to the main heat exchanger 1355. Refrigerant stream 1360 from the refrigeration unit 1365 is passed to the main heat exchanger 1355 to further chill chilled stream 1350. The refrigerant stream is flashed and cooled via joule-Thompson cooling before further cooling the fractionation column overhead vapor. The heated refrigerant stream 1370 is returned to the refrigeration unit 1365.

The chilled stream 1375 is passed to a NO₂/SO₂ removal section 1376 where liquid stream 1377 containing the heavy nitrogen oxide compounds and/or the sulfur oxide compounds is removed. Reboiler inlet stream 1445 from the NO₂/SO₂ removal section 1376 is sent to the quench column section 1215 where warm circulating water is used to partially vaporize the stream. The partially vaporized stream is then returned to the NO₂/SO₂ removal section 1376.

The gas stream 1378 from the NO₂/SO₂ removal section 1376 is sent to the CO₂ fractionation column 1335 where it is separated into the carbon dioxide-enriched product stream 1380 and overhead gas stream 1385. The overhead gas stream 1385 is passed to the main heat exchanger 1355 where it is chilled. The chilled overhead stream 1390 is passed to accumulator 1395 where it is separated into a liquid CO₂ reflux stream 1400 and a second overhead gas stream 1405. The liquid CO₂ reflux stream 1400 is returned to the fractionation column 1335.

The second overhead gas stream 1405 is passed to the main heat exchanger 1355 where it is heated. The heated second overhead stream 1410 is expanded in expander 1412, heated in the main heat exchanger 1355, and the heated expanded second overhead stream 1414 is recycled to the CO₂ PSA unit 1265.

The off gas stream 1275 is expanded in off gas expander 1450, and the expanded off gas stream 1455 is heated in main heat exchanger 1355. The heated expanded off gas stream 1460 is heat exchanged with the compressed refrigerant stream 1360 and vented to the atmosphere.

The CO₂-enriched product stream 1380 is heat exchanged and vaporized with the compressed tail gas stream 1285.

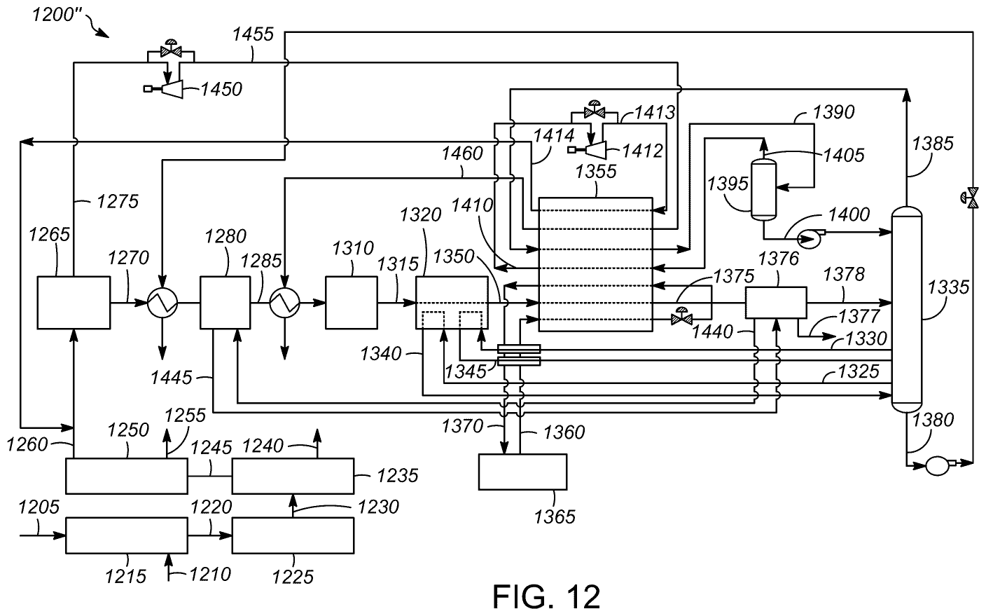

FIG. 12 illustrates another integrated process 1200″ for the recovery of carbon dioxide from a flue gas stream using an NO₂/SO₂ removal section with an NO₂—SO₂ fractionation column with a dual cooling stage.

The flue gas feed stream 1205 comprises carbon dioxide and at least one of a nitrogen oxide compound, a sulfur oxide compound, and ammonia. The flue gas feed stream 1205 and a water stream 1210 are sent to an optional quench column or scrubber 1215 to cool the flue gas feed stream and to remove HCl and HF. The water stream 1210 may include a neutralizing agent. When the neutralizing agent is included, SO₂ may also be recovered.

The quenched flue gas stream 1220 from the optional quench column or scrubber 1215 is sent to the flue gas compressor 1225 where it is compressed from a pressure in a range of 75 to 150 kPa to a pressure in the range of 600 to 3100 kPa.

The compressed flue gas stream 1230 is sent to an optional guard bed 1235 to remove one or more of Hg(0), Hg(2+), heavy metals, hydrocarbons, heavy nitrogen oxide compounds and/or sulfur oxide compounds in waste stream 1240. Suitable guard beds include, but are not limited to, carbon guard beds, zeolite-based guard bed, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 1245 from the optional guard bed 1235 is sent to an optional particulate polishing unit 1250 where a particulate stream 1255 is removed. Suitable particulate polishing units include, but are not limited to, a cartridge filter, a baghouse, and the like.

The effluent 1260 from the optional particulate polishing unit 1250 is sent to a CO₂ PSA unit 1265, which can be a standard CO₂ PSA unit or a CO₂ vacuum pressure swing adsorption (VPSA) unit. The effluent 1260 is separated into a CO₂-enriched tail gas stream 1270 and an off gas stream 1275.

The CO₂-enriched tail gas stream 1270 is sent to a tail gas compressor 1280 where it is compressed to a pressure in a range of 2300 to 5000 kPa.

The compressed tail gas stream 1285 is dried in a dehydration unit 1310. Suitable dehydration units include, but are not limited to, a triethylene glycol unit, an activated alumina or a silica gel or a molecular sieve (zeolite A or X) or a combination thereof-based temperature swing adsorption process and the like.

The dried compressed tail gas stream 1315 is passed to column reboiler 1320. First side reboiler stream 1325 and second side reboiler stream 1330 from the CO₂ fractionation column 1335 are passed to the column reboiler 1320 to chill the dried compressed tail gas stream 1315 from 20-50° C. to a temperature in a range of −10° C. to 15° C. The heated first side reboiler stream 1340 and heated second side reboiler stream 1345 are returned to the CO₂ fractionation column 1335.

Chilled stream 1350 is passed to the main heat exchanger 1355. Refrigerant stream 1360 from the refrigeration unit 1365 is passed to the main heat exchanger 1355 to further chill chilled stream 1350. The refrigerant stream is flashed and cooled via joule-thompson cooling before further cooling the fractionation column overhead vapor. The heated refrigerant stream 1370 is returned to the refrigeration unit 1365.

The chilled stream 1375 is passed to a NO₂/SO₂ removal section 1376 where liquid stream 1377 containing the heavy nitrogen oxide compounds and/or the sulfur oxide compounds is removed. Reboiler inlet stream 1445 from the NO₂/SO₂ removal section 1376 is sent to the tail gas compressor 1280, where the interstage coolers as used to partially vaporize the stream. The partially vaporized stream 1440 is then returned to the NO₂/SO₂ removal section 1376.

The gas stream 1378 from the NO₂/SO₂ removal section 1376 is sent to the CO₂ fractionation column 1335 where it is separated into the carbon dioxide-enriched product stream 1380 and overhead gas stream 1385. The overhead gas stream 1385 is passed to the main heat exchanger 1355 where it is chilled. The chilled overhead stream 1390 is passed to accumulator 1395 where it is separated into a liquid CO₂ reflux stream 1400 and a second overhead gas stream 1405. The liquid CO₂ reflux stream 1400 is returned to the fractionation column 1335.

The second overhead gas stream 1405 is passed to the main heat exchanger 1355 where it is heated. The heated second overhead stream 1410 is expanded in expander 1412, heated in the main heat exchanger 1355, and the heated expanded second overhead stream 1414 is recycled to the CO₂ PSA unit 1265.

The off gas stream 1275 is expanded in off gas expander 1450, and the expanded off gas stream 1455 is heated in main heat exchanger 1355. The heated expanded off gas stream 1460 is heat exchanged with the compressed tail gas stream 1285 and vented to the atmosphere.

The CO₂ enriched product stream 1380 is heat exchanged and vaporized with the tail gas stream 1270.

Another process involves a CO₂ PSA without the use of cryogenic fractionation. The process concentrates CO₂ while minimizing compression and energy usage, reducing equipment count, and avoiding the need for brazed aluminum exchangers. It also lessens the sensitivity of the unit to mercury in the feed gas. The oxidation process meets NOx and SOx specifications for the CO₂ product while avoiding large and costly pretreatment units. The corresponding compounds can be removed from the CO₂ via wet gas scrubbing and/or temperature swing adsorption (TSA) if needed to meet the product spec and environmental limits. CO can be oxidized to CO₂ if needed. Organic carbon species will be oxidized to CO₂. The addition of hydrogen reacts remaining oxygen to form water and allow the CO₂ product to meet tight product specs. The cofeed configuration coupled with oxidation and the addition of hydrogen meets the strict CO₂ product specifications. The flowscheme is particularly useful where less strict specifications of N₂ in the CO₂ product are seen, and where a liquid CO₂ product is not seen.

The flue gas may optionally be quenched by a quench column, depending on the feed temperature. The gas will then be compressed to 800 to 3500 kpag, mixed with compressed tail gas and sent to a CO₂ PSA unit. The CO₂ PSA preferentially separates CO₂ from N₂, O₂ and NO. The tail gas is co-fed to the CO₂ PSA to achieve sufficient concentration of CO₂ in the tail gas. A portion of the tail gas is split and sent back to the CO₂ PSA as co-feed. The rest of the tail gas goes on to an oxidation step where CO is oxidized to CO₂, NO is oxidized to NO₂, hydrocarbons are oxidized to CO₂, and oxygen is converted to water. If additional treatment of NOx is required, reduction via NH₃ at elevated temperatures can also be used. The CO₂ water content is lowered in the dehydration section, and any remaining NH₃ is also removed. Additional compression may be used to meet CO2 product pressure requirements.

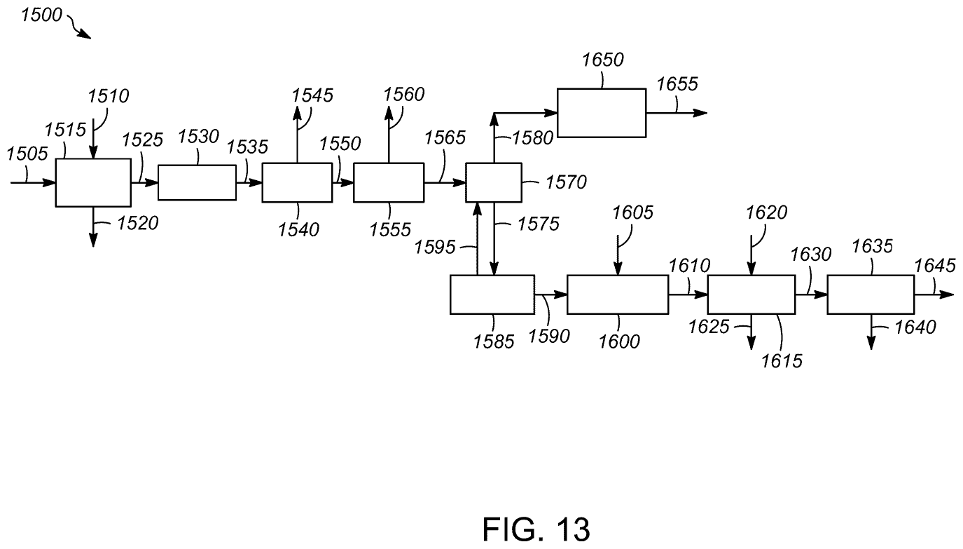

FIG. 13 illustrates a process 1500 for recovery of CO₂ from a flue gas stream using a water wash unit and a CO₂ PSA unit without a CO₂ fractionation column.

The flue gas feed stream 1505 comprises carbon dioxide and at least one of a nitrogen oxide compound, a sulfur oxide compound, and ammonia. The flue gas feed stream 1505 and a water stream 1510 are sent to an optional quench column or scrubber 1515 to cool the flue gas feed stream 1505 and to remove HCl and HF in waste stream 1520. The quench column includes a circulating loop of quench water with a cooler to maintain the temperature. The water stream 1510 may include a neutralizing agent. When the neutralizing agent is included, SO₂ may also be recovered in waste stream 1520. Dry sorbent injection may also be used to reduce the concentration of SO₃ and/or mercury, and additional particulate filtration may be added to reduce the concentration of particulates to the downstream compressors.

The quenched flue gas stream 1525 from the optional quench column or scrubber 1515 is sent to the flue gas feed compressor 1530 where it is compressed from a pressure in a range of 75 to 150 kPa to a pressure in the range of 600 to 3100 kPa.

The compressed flue gas stream 1535 is sent to an optional guard bed 1540 to remove one or more of Hg(0), Hg(2+), heavy metals, hydrocarbons, heavy nitrogen oxide compounds and/or sulfur oxide compounds in waste stream 1545. Suitable guard beds include, but are not limited to, carbon guard beds, zeolite-based guard bed, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 1550 from the optional guard bed 1540 is sent to an optional particulate polishing unit 1555 where a particulate stream 1560 is removed. Suitable particulate polishing units include, but are not limited to, a cartridge filter, a baghouse, and the like.

The effluent 1565 from the optional particulate polishing unit 1555 is sent to a CO₂ PSA unit 1570, which can be a standard CO₂ PSA unit or a CO₂ vacuum pressure swing adsorption (VPSA) unit. The effluent 1565 is separated into a CO₂-enriched tail gas stream 1575 and an off gas stream 1580.

The CO₂-enriched tail gas stream 1575 is sent to a tail gas compressor 1585 where it is compressed to a pressure in a range of 1500 to 4500 kPa.

The compressed tail gas stream 1590 is sent to a reactor 1600 containing a catalyst. Another compressed tail gas stream 1595 is returned to the CO₂ PSA unit 1570.

A stream 1605 comprising carbon monoxide and/or hydrogen can be added to the reactor 1600. The carbon monoxide, oxygen, and hydrogen are catalytically converted to carbon dioxide and water.

The reactor effluent stream 1610 is sent to an optional quench column or scrubber 1615 along with a water stream 1620 to remove NO₂ and SO₂ by forming dilute sulfuric acid, nitrous acid, and nitric acid in waste stream 1625.

The effluent 1630 from the optional quench column or scrubber 1615 is sent to a dehydration unit 1635 to remove a water stream 1640 producing the CO₂ product stream 1645. The CO₂ product may be further compressed or liquefied to meet CO₂ product pressure specifications.

The off gas stream 1580 can optionally be sent to an expander to 1650 for power recovery and heat recovery. The expanded off gas stream 1655 can be vented to the atmosphere.

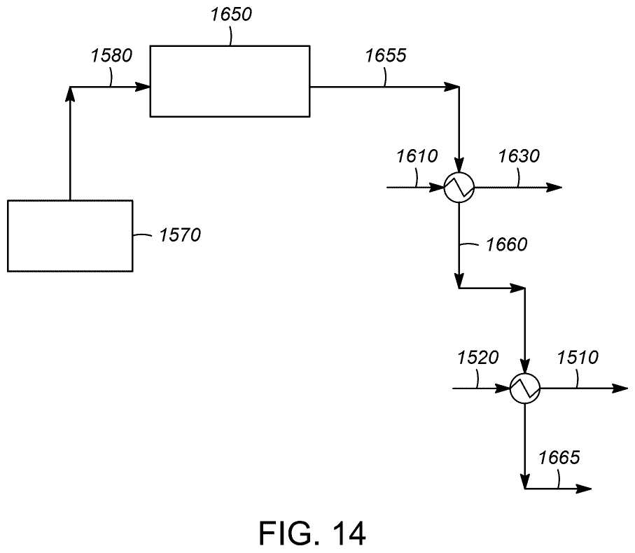

FIG. 14 illustrates one embodiment for heat exchange in the process of claim 13. The off gas stream 1580 from the CO₂ PSA unit 1570 is expanded in the expander 1650 producing cold expanded off gas stream 1655. The cold expanded off gas stream 1655 can be heat exchanged with the reactor effluent stream 1610, and the cooled reactor effluent stream is sent to the optional quench column or scrubber 1615 or the dehydration unit 1635.

After the heat exchange with the reactor effluent stream 1610, the warmed expanded flue gas stream 1660 can be heat exchanged with the warm circulating water stream from the quench column or scrubber 1515 cooling it for use as a recycle water stream in the quench column or scrubber 1515.

The resulting warmed expanded flue gas stream 1665 can be vented to the atmosphere.

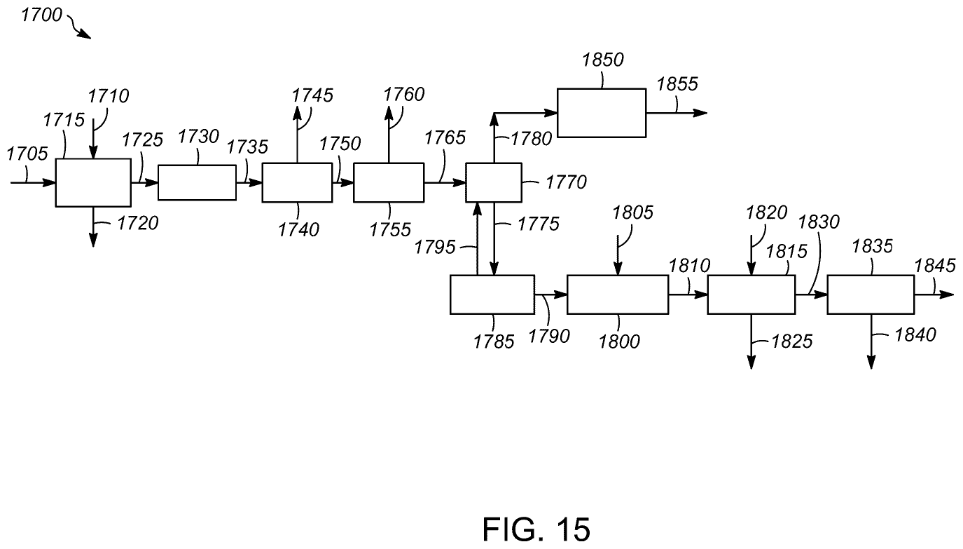

FIG. 15 illustrates a process 1700 for recovery of CO₂ from a flue gas stream using a scrubbing column and a CO₂ PSA unit without a CO₂ fractionation column.

The flue gas feed stream 1705 comprises carbon dioxide and at least one of a nitrogen oxide compound, a sulfur oxide compound, and ammonia. The flue gas feed stream 1705 and a water stream, optionally including a neutralizing agent, stream 1710 are sent to a scrubbing column 1715 to cool the flue gas feed stream 1705 and to remove HCl, HF and SO₂ along with any reactant products with the neutralizing agent in waste stream 1720. Dry sorbent injection may also be used to reduce the concentration of SO₃ and/or mercury, and additional particulate filtration may be added to reduce the concentration of particulates to the downstream compressors.

The flue gas stream 1725 from the scrubbing column 1715 is sent to the flue gas feed compressor 1730 where it is compressed from a pressure in a range of 75 to 150 kPa to a pressure in the range of 600 to 3100 kPa.

The compressed flue gas stream 1735 is sent to an optional guard bed 1740 to remove one or more of Hg(0), Hg(2+), heavy metals, hydrocarbons, heavy nitrogen oxide compounds and/or sulfur oxide compounds in waste stream 1745. Suitable guard beds include, but are not limited to, carbon guard beds, zeolite-based guard bed, including sacrificial or regenerative guard beds, and the like. Heavy metals include, but are not limited to, arsenic, cadmium, chromium, nickel, lead, thallium, barium, strontium, manganese, titanium, vanadium, beryllium, copper, tin, zinc, or combinations thereof. Hydrocarbons include, but are not limited to, C₁₂-paraffins, olefins, diolefins, aromatics, halogenated hydrocarbons, oxygenates, or combinations thereof.

The effluent stream 1750 from the optional guard bed 1740 is sent to an optional particulate polishing unit 1755 where a particulate stream 1760 is removed. Suitable particulate polishing units include, but are not limited to, a cartridge filter, a baghouse, and the like.

The effluent 1765 from the optional particulate polishing unit 1755 is sent to a CO₂ PSA unit 1770, which can be a standard CO₂ PSA unit or a CO₂ vacuum pressure swing adsorption (VPSA) unit. The effluent 1765 is separated into a CO₂-enriched tail gas stream 1775 and an off gas stream 1780.

The CO₂-enriched tail gas stream 1775 is sent to a tail gas compressor 1785 where it is compressed to a pressure in a range of 1500 to 4500 kPa.

The compressed tail gas stream 1790 is sent to a reactor 1800 containing a catalyst. Another compressed tail gas stream 1795 is returned to the CO₂ PSA unit 1770.

A stream 1805 comprising carbon monoxide and/or hydrogen can be added to the reactor 1800. The carbon monoxide, oxygen, and hydrogen are catalytically converted to carbon dioxide and water.

The reactor effluent 1810 is sent to an optional quench column or scrubber 1815 along with a water stream 1820 to remove NO₂ and SO₂ by forming dilute sulfuric acid, nitrous acid, and/or nitric acid in waste stream 1825.

The effluent 1830 from the optional quench column or scrubber 1815 is sent to a dehydration unit 1835 to remove a water stream 1840 producing the CO₂ product stream 1845. The CO₂ product may be further compressed or liquefied to meet CO₂ product pressure specifications.

The off gas stream 1870 can optionally be sent to an expander to 1850 for power recovery and heat recovery. The expanded off gas stream 1855 can be vented to the atmosphere.

### Specific Embodiments

While the following is described in conjunction with specific embodiments, it will be understood that this description is intended to illustrate and not limit the scope of the preceding description and the appended claims.

A first embodiment of the invention is a process for recovery of carbon dioxide from a flue gas stream comprising compressing a flue gas feed stream forming a compressed flue gas stream, wherein the flue gas feed stream comprises carbon dioxide, and a nitrogen oxide compound, or a sulfur oxide compound, or ammonia, or combinations thereof; separating the compressed flue gas feed stream in a CO₂ pressure swing adsorption (PSA) unit to form a CO₂-enriched tail gas stream, and an off gas stream; compressing the CO₂-enriched tail gas stream in a tail gas compressor forming a compressed tail gas stream; removing at least a portion of the nitrogen oxide compound, or the sulfur oxide compound, or combinations thereof from the compressed tail gas stream in a nitrogen oxide and sulfur oxide removal zone forming a reduced contaminant gas stream wherein a level of the nitrogen oxide compound or the sulfur oxide compound or combinations thereof in the reduced contaminant gas stream is less than a level of the nitrogen oxide compound or the sulfur oxide compound or combinations thereof in the compressed tail gas stream; or removing at least a portion of the nitrogen oxide compound from the compressed tail gas stream in a water wash unit forming a reduced contaminant compressed tail gas stream, wherein a level of the nitrogen oxide compound in the reduced contaminant compressed tail gas stream is less than a level of the nitrogen oxide compound in the compressed tail gas stream; or both; and fractionating the compressed gas stream or the reduced contaminant gas stream in a CO₂ fractionation column into a carbon dioxide-enriched product stream and an overhead gas stream. An embodiment of the invention is one, any or all of prior embodiments in this paragraph up through the first embodiment in this paragraph further comprising quenching the flue gas feed stream with water to cool the flue gas feed stream and remove HCl, or HF, or both from the flue gas feed stream before compressing the flue gas feed stream. An embodiment of the invention is one, any or all of prior embodiments in this paragraph up through the first embodiment in this paragraph further comprising quenching the flue gas feed stream with a neutralizing agent to remove HCl, or HF, or SO₂, or combinations thereof from the flue gas feed stream before compressing the flue gas feed stream. An embodiment of the invention is one, any or all of prior embodiments in this paragraph up through the first embodiment in this paragraph wherein the flue gas feed stream further comprises Hg(0), or Hg(2+), or SO₃, or a heavy metal, or a hydrocarbon, or particulate, or combinations thereof, further comprising removing at least a portion of the Hg(0), or the Hg(2+), or the SO₃, or the heavy metal, or the hydrocarbon, or the particulate, or combinations thereof from the flue gas feed stream, or from the compressed flue gas stream before separating the compressed flue gas stream in the CO₂ PSA unit, or both. An embodiment of the invention is one, any or all of prior embodiments in this paragraph up through the first embodiment in this paragraph wherein removing at least a portion of the Hg(0), or the Hg(2+), or the SO₃, or the heavy metal, or the hydrocarbon, or the particulate, or combinations thereof from the flue gas feed stream, or from the compressed flue gas stream comprises passing the flue gas feed stream, or the compressed flue gas stream through a guard bed to remove at least the portion of the Hg(0), or the Hg(2+), or the SO₃, or the heavy metal, or the hydrocarbons, or the particulate, or combinations thereof; or passing the flue gas feed stream, or the compressed flue gas through a filter or a baghouse to remove the particulate, or the heavy metal, or combinations thereof; or both. An embodiment of the invention is one, any or all of prior embodiments in this paragraph up through the first embodiment in this paragraph further comprising drying the compressed tail gas stream and removing ammonia from the compressed tail gas stream in a dehydration unit. An embodiment of the invention is one, any or all of prior embodiments in this paragraph up through the first embodiment in this paragraph wherein removing at least a portion of the nitrogen oxide compound from the compressed tail gas stream in the water wash unit comprises contacting the compressed tail stream with water and optionally a neutralizing agent. An embodiment of the invention is one, any or all of prior embodiments in this paragraph up through the first embodiment in this paragraph wherein the nitrogen oxide and sulfur oxide removal section comprises a separator and a NO₂—SO₂ fractionation column and wherein removing at least a portion of the nitrogen oxide compound, or the sulfur oxide compound, or combinations thereof from the compressed tail gas stream comprises drying the compressed stream forming a dried compressed tail gas stream; chilling the dried compressed tail gas stream to form a chilled compressed tail gas stream; separating the chilled compressed tail gas stream in an NO₂—SO₂ fractionation column into an overhead gas stream lean in the nitrogen oxide compound, or a sulfur oxide compound, or both and a bottom stream enriched in the nitrogen oxide compound, the sulfur oxide compound, or combinations thereof; and passing the overhead gas stream from the NO₂—SO₂ fractionation column to the CO₂ fractionation column. An embodiment of the invention is one, any or all of prior embodiments in this paragraph up through the first embodiment in this paragraph further comprising separating the chilled compressed tail gas stream into an overhead gas stream comprising CO₂, N₂ and an amount of the nitrogen oxide compound, or the sulfur oxide compound, or combinations thereof less than an amount of the nitrogen oxide compound, or the sulfur oxide compound, or combinations thereof in the chilled compressed tail gas stream and a liquid stream comprising CO₂ and enriched in the nitrogen oxide compound, or the sulfur oxide compound, or combinations thereof in a gas-liquid separator before separating the chilled compressed tail gas stream in the NO₂—SO₂ fractionation column; and passing the overhead gas stream from the separator to the CO₂ fractionation column. An embodiment of the invention is one, any or all of prior embodiments in this paragraph up through the first embodiment in this paragraph further comprising chilling the dried compressed tail gas stream forming a chilled compressed tail gas stream; and chilling the chilled compressed tail gas stream with a refrigerant stream forming a second chilled tail gas stream. An embodiment of the invention is one, any or all of prior embodiments in this paragraph up through the first embodiment in this paragraph wherein the nitrogen oxide or sulfur oxide removal zone comprises first and second separators and a NO₂—SO₂ fractionation column, and wherein removing at least a portion of the nitrogen oxide compound, or the sulfur oxide compound, or combinations thereof from the dried compressed tail gas stream comprises cooling the second chilled compressed gas stream; separating the second chilled compressed gas stream into an overhead gas stream comprising CO₂, N₂ and an amount of the nitrogen oxide compound, or the sulfur oxide compound, or combinations thereof less than an amount of the nitrogen oxide compound, or the sulfur oxide compound, or combinations thereof in the second chilled compressed gas stream and a liquid stream comprising CO₂, the nitrogen oxide compound, or the sulfur oxide compound in the first separator; separating the liquid stream from the first separator in an NO₂—SO₂ fractionation column into an overhead gas stream lean in the nitrogen oxide compound, or the sulfur oxide compound, or combinations thereof and a bottom stream enriched in the nitrogen oxide compound, or the sulfur oxide compound, or combinations thereof; cooling the overhead gas stream from the first separator; separating the cooled overhead gas stream from the first separator into a second overhead gas stream and a second liquid stream in the second separator; passing the second liquid stream to the NO₂—SO₂ fractionation column; and passing the overhead gas stream from the second separator and the overhead gas stream from the NO₂—SO₂ fractionation column to the CO₂ fractionation column. An embodiment of the invention is one, any or all of prior embodiments in this paragraph up through the first embodiment in this paragraph further comprising chilling the compressed tail gas with the carbon dioxide enriched product stream before drying the compressed tail gas stream. An embodiment of the invention is one, any or all of prior embodiments in this paragraph up through the first embodiment in this paragraph further comprising chilling the overhead gas stream from the CO₂ fractionation column to form a chilled overhead gas stream; separating the chilled overhead gas stream into a liquid CO₂ reflux stream and a second overhead gas stream in an accumulator; and passing the liquid CO₂ reflux stream to the CO₂ fractionation column. An embodiment of the invention is one, any or all of prior embodiments in this paragraph up through the first embodiment in this paragraph further comprising heating the second overhead gas stream from the accumulator to form a heated second overhead gas stream; and recycling the heated second overhead stream to the CO₂ PSA unit. An embodiment of the invention is one, any or all of prior embodiments in this paragraph up through the first embodiment in this paragraph further comprising sending the heated second overhead stream to an expander to generate power or decrease the power of the feed gas compressor or the tail gas compressor, forming a cooled recycle gas stream; and optionally cooling the compressed tail gas stream, or circulating quench water from a quench column, or a refrigerant stream, or the overhead gas stream from the CO₂ fractionation column with the cooled second overhead gas stream from the expander. An embodiment of the invention is one, any or all of prior embodiments in this paragraph up through the first embodiment in this paragraph further comprising passing the off gas stream from the PSA or VPSA to an expander to generate power or directly decrease the power of a compressor in the one of the units forming a cooled vent gas stream; and optionally cooling the compressed tail gas stream or a compressor interstage cooler or a quench water cooler from the quench column or any combination thereof with the cooled vent gas stream from the expander. An embodiment of the invention is one, any or all of prior embodiments in this paragraph up through the first embodiment in this paragraph wherein the flue gas feed stream comprises a flue gas stream from a pulp plant, a flue gas stream from a paper plant, a flue gas stream from a cement plant, a CO₂ rich stream from a steel plant, a flue gas stream from a fluid catalytic cracking (FCC) unit, a flue gas stream from a boiler, a flue gas stream from a fired heater, a flue gas stream from a power generation plant using coal, natural gas, or biomass, or combinations thereof. An embodiment of the invention is one, any or all of prior embodiments in this paragraph up through the first embodiment in this paragraph further comprising drying the compressed tail gas stream to form a dried compressed tail gas stream using temperature swing adsorption, and wherein a desorption gas is the carbon dioxide-enriched product stream, or a CO₂ lean flue gas from the CO₂ PSA, or a dried compressed tail gas stream. An embodiment of the invention is one, any or all of prior embodiments in this paragraph up through the first embodiment in this paragraph further comprising recycling the overhead gas stream to the CO₂ PSA unit to increase CO₂ recovery.

A second embodiment of the invention is a process for recovery of carbon dioxide from a flue gas stream comprising compressing a flue gas feed stream comprising carbon dioxide, and at least one of carbon monoxide, oxygen, a nitrogen oxide compound, a sulfur oxide compound, and ammonia forming a compressed flue gas stream; separating the compressed flue gas feed stream in a CO₂ pressure swing adsorption (PSA) unit to form a CO₂-enriched tail gas stream, and an off gas stream; compressing the CO₂-enriched tail gas stream in a tail gas compressor forming a compressed tail gas stream; passing the compressed tail gas stream to a reactor comprising a catalyst; catalytically converting carbon monoxide and oxygen into carbon dioxide in a reactor forming a reactor effluent; and optionally injecting hydrogen or carbon monoxide or both into the reactor and catalytically converting the carbon monoxide, oxygen, and the hydrogen into carbon dioxide and water in the reactor effluent. An embodiment of the invention is one, any or all of prior embodiments in this paragraph up through the second embodiment in this paragraph further comprising contacting the compressed tail stream with water and optionally a neutralizing agent to remove at least a portion of the nitrogen oxide compound. An embodiment of the invention is one, any or all of prior embodiments in this paragraph up through the second embodiment in this paragraph further comprising quenching the flue gas feed stream with water to cool the flue gas feed stream and remove HCl, or HF, or both from the flue gas feed stream before compressing the flue gas feed stream. An embodiment of the invention is one, any or all of prior embodiments in this paragraph up through the second embodiment in this paragraph further comprising quenching the flue gas feed stream with a neutralizing agent to remove HCl, or HF, or SO₂, or combinations thereof from the flue gas stream before compressing the flue gas stream. An embodiment of the invention is one, any or all of prior embodiments in this paragraph up through the second embodiment in this paragraph further comprising removing Hg(0), or Hg(2+), or a heavy metal, or a hydrocarbon, or particulate, or combinations thereof from the compressed flue gas stream before separating the compressed flue gas stream in the CO₂ PSA unit. An embodiment of the invention is one, any or all of prior embodiments in this paragraph up through the second embodiment in this paragraph wherein removing the Hg(0), or the Hg(2+), or the heavy metal, or the hydrocarbon, or the particulate, or combinations thereof from the compressed flue gas stream comprises passing the compressed flue gas stream through a guard bed to remove the Hg(0), or the Hg(2+), or the heavy metal, or the hydrocarbon, or the particulate; or passing the compressed flue gas through a Brownian diffusion filter or a baghouse to remove heavy metal, or the particulate, or combinations thereof; or combinations thereof. An embodiment of the invention is one, any or all of prior embodiments in this paragraph up through the second embodiment in this paragraph further comprising passing a portion of the compressed tail gas stream to the CO₂ PSA unit to control O₂ and CO in the CO₂-enriched tail gas stream. An embodiment of the invention is one, any or all of prior embodiments in this paragraph up through the second embodiment in this paragraph further comprising introducing the portion of the compressed tail gas stream after the feed step where the pressure is same as feed pressure of the CO₂ PSA unit, or introducing the portion of the compressed tail gas stream after the feed step where the pressure is lower than the feed pressure of the CO₂ PSA unit. An embodiment of the invention is one, any or all of prior embodiments in this paragraph up through the second embodiment in this paragraph further comprising recovering heat from the off gas stream. An embodiment of the invention is one, any or all of prior embodiments in this paragraph up through the second embodiment in this paragraph further comprising passing the reactor effluent through an adsorbent to remove Hg(0), or Hg(2+), or both. An embodiment of the invention is one, any or all of prior embodiments in this paragraph up through the second embodiment in this paragraph further comprising passing the off gas stream to an expander to generate power or to decrease the power of the compressors in the one of the units forming a cooled off gas stream; and optionally cooling the reactor effluent or a water stream from a water quench unit with the cooled off gas stream from the expander. An embodiment of the invention is one, any or all of prior embodiments in this paragraph up through the second embodiment in this paragraph further comprising drying the reactor effluent using temperature swing adsorption to form a CO₂ product stream wherein a desorption gas is the CO2 product stream or the off gas stream from CO₂ PSA unit.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for recovery of carbon dioxide from a flue gas stream comprising:
compressing a flue gas feed stream forming a compressed flue gas stream, wherein the flue gas feed stream comprises carbon dioxide, and a nitrogen oxide compound, or a sulfur oxide compound, or ammonia, or combinations thereof;
separating the compressed flue gas feed stream in a CO₂ pressure swing adsorption (PSA) unit to form a CO₂-enriched tail gas stream, and an off gas stream;
compressing the CO₂-enriched tail gas stream in a tail gas compressor forming a compressed tail gas stream;
removing at least a portion of a heavy nitrogen oxide compound, or the sulfur oxide compound, or combinations thereof from the compressed tail gas stream in a heavy nitrogen oxide and sulfur oxide removal zone forming a reduced contaminant gas stream wherein a level of the heavy nitrogen oxide compound or the sulfur oxide compound or combinations thereof in the reduced contaminant gas stream is less than a level of the heavy nitrogen oxide compound or the sulfur oxide compound or combinations thereof in the compressed tail gas stream; or removing at least a portion of the heavy nitrogen oxide compound from the compressed tail gas stream in a water wash unit forming a reduced contaminant compressed tail gas stream, wherein a level of the heavy nitrogen oxide compound in the reduced contaminant compressed tail gas stream is less than a level of the heavy nitrogen oxide compound in the compressed tail gas stream; or both; and
fractionating the compressed gas stream or the reduced contaminant gas stream in a CO₂ fractionation column into a carbon dioxide-enriched product stream and an overhead gas stream.

2. The process of claim 1 further comprising:
quenching the flue gas feed stream with water to cool the flue gas feed stream and remove HCl, or HF, or both from the flue gas feed stream before compressing the flue gas feed stream.

3. The process of claim 1 further comprising:
quenching the flue gas feed stream with a neutralizing agent to remove HCl, or HF, or SO₂, or combinations thereof from the flue gas feed stream before compressing the flue gas feed stream.

4. The process of claim 1 wherein the flue gas feed stream further comprises Hg(0), or Hg(2+), or SO₃, or a heavy metal, or a hydrocarbon, or particulate, or combinations thereof, further comprising:
removing at least a portion of the Hg(0), or the Hg(2+), or the SO₃, or the heavy metal, or the hydrocarbon, or the particulate, or combinations thereof from the flue gas feed stream, or from the compressed flue gas stream before separating the compressed flue gas stream in the CO₂ PSA unit, or both.

5. The process of claim 4 wherein removing at least a portion of the Hg(0), or the Hg(2+), or the SO₃, or the heavy metal, or the hydrocarbon, or the particulate, or combinations thereof from the flue gas feed stream, or from the compressed flue gas stream comprises:
passing the flue gas feed stream, or the compressed flue gas stream through a guard bed to remove at least the portion of the Hg(0), or the Hg(2+), or the SO₃, or the heavy metal, or the hydrocarbons, or the particulate, or combinations thereof; or
passing the flue gas feed stream, or the compressed flue gas through a filter or a baghouse to remove the particulate, or the heavy metal, or combinations thereof; or
both.

6. The process of claim 1 further comprising:
drying the compressed tail gas stream and removing ammonia from the compressed tail gas stream in a dehydration unit.

7. The process of claim 1 wherein removing at least a portion of the heavy nitrogen oxide compound from the compressed tail gas stream in the water wash unit comprises:
contacting the compressed tail stream with water and optionally a neutralizing agent.

8. The process of claim 1 wherein the heavy nitrogen oxide and sulfur oxide removal section comprises a separator and a NO₂—SO₂ fractionation column and wherein removing at least a portion of the heavy nitrogen oxide compound, or the sulfur oxide compound, or combinations thereof from the compressed tail gas stream comprises:
drying the compressed stream forming a dried compressed tail gas stream;
chilling the dried compressed tail gas stream to form a chilled compressed tail gas stream;
separating the chilled compressed tail gas stream in an NO₂—SO₂ fractionation column into an overhead gas stream lean in the heavy nitrogen oxide compound, or the sulfur oxide compound, or both and a bottom stream enriched in the heavy nitrogen oxide compound, the sulfur oxide compound, or combinations thereof; and
passing the overhead gas stream from the NO₂—SO₂ fractionation column to the CO₂ fractionation column.

9. The process of claim 8 further comprising:
separating the chilled compressed tail gas stream into an overhead gas stream comprising CO₂, N₂ and an amount of the heavynitrogen oxide compound, or the sulfur oxide compound, or combinations thereof less than an amount of the heavynitrogen oxide compound, or the sulfur oxide compound, or combinations thereof in the chilled compressed tail gas stream and a liquid stream comprising CO₂ and enriched in the heavy nitrogen oxide compound, or the sulfur oxide compound, or combinations thereof in a gas-liquid separator before separating the chilled compressed tail gas stream in the NO₂—SO₂ fractionation column; and
passing the overhead gas stream from the separator to the CO₂ fractionation column.

10. The process of claim 1 further comprising:
chilling the dried compressed tail gas stream forming a chilled compressed tail gas stream; and
chilling the chilled compressed tail gas stream with a refrigerant stream forming a second chilled tail gas stream.

11. The process of claim 10 wherein the heavy nitrogen oxide or sulfur oxide removal zone comprises first and second separators and a NO₂—SO₂ fractionation column, and wherein removing at least a portion of the nitrogen oxide compound, or the sulfur oxide compound, or combinations thereof from the dried compressed tail gas stream comprises:
cooling the second chilled compressed gas stream;
separating the second chilled compressed gas stream into an overhead gas stream comprising CO₂, N₂ and an amount of the heavy nitrogen oxide compound, or the sulfur oxide compound, or combinations thereof less than an amount of the heavy nitrogen oxide compound, or the sulfur oxide compound, or combinations thereof in the second chilled compressed gas stream and a liquid stream comprising CO₂, the heavy nitrogen oxide compound, or the sulfur oxide compound in the first separator;
separating the liquid stream from the first separator in an NO₂—SO₂ fractionation column into an overhead gas stream lean in the heavy nitrogen oxide compound, or the sulfur oxide compound, or combinations thereof and a bottom stream enriched in the heavy nitrogen oxide compound, or the sulfur oxide compound, or combinations thereof;
cooling the overhead gas stream from the first separator;
separating the cooled overhead gas stream from the first separator into a second overhead gas stream and a second liquid stream in the second separator;
passing the second liquid stream to the NO₂—SO₂ fractionation column; and
passing the overhead gas stream from the second separator and the overhead gas stream from the NO₂—SO₂ fractionation column to the CO₂ fractionation column.

12. The process of claim 10 further comprising:
chilling the compressed tail gas with the carbon dioxide enriched product stream before drying the compressed tail gas stream.

13. The process of claim 10 further comprising:
chilling the overhead gas stream from the CO₂ fractionation column to form a chilled overhead gas stream;
separating the chilled overhead gas stream into a liquid CO₂ reflux stream and a second overhead gas stream in an accumulator; and
passing the liquid CO₂ reflux stream to the CO₂ fractionation column.

14. The process of claim 13 further comprising:
heating the second overhead gas stream from the accumulator to form a heated second overhead gas stream; and
recycling the heated second overhead stream to the CO₂ PSA unit.

15. The process of claim 14 further comprising:
sending the heated second overhead stream to an expander to generate power or decrease the power of the feed gas compressor or the tail gas compressor, forming a cooled recycle gas stream; and
optionally cooling the compressed tail gas stream, or circulating quench water from a quench column, or a refrigerant stream, or the overhead gas stream from the CO₂ fractionation column with the cooled second overhead gas stream from the expander.

16. The process of claim 15 further comprising:
passing the off gas stream from the PSA or VPSA to an expander to generate power or directly decrease the power of a compressor in the one of the units forming a cooled vent gas stream; and
optionally cooling the compressed tail gas stream or a compressor interstage cooler or a quench water cooler from the quench column or any combination thereof with the cooled vent gas stream from the expander.

17. The process of claim 1 wherein the flue gas feed stream comprises a flue gas stream from a pulp plant, a flue gas stream from a paper plant, a flue gas stream from a cement plant, a CO₂ rich stream from a steel plant, a flue gas stream from a fluid catalytic cracking (FCC) unit, a flue gas stream from a boiler, a flue gas stream from a fired heater, a flue gas stream from a power generation plant using coal, natural gas, or biomass, or combinations thereof.

18. The process of claim 1 further comprising:
drying the compressed tail gas stream to form a dried compressed tail gas stream using temperature swing adsorption, and wherein a desorption gas is the carbon dioxide-enriched product stream, or a CO₂ lean flue gas from the CO₂ PSA, or a dried compressed tail gas stream.

19. The process of claim 1 further comprising:
recycling the overhead gas stream to the CO₂ PSA unit to increase CO₂ recovery.

20. A process for recovery of carbon dioxide from a flue gas stream comprising:
compressing a flue gas feed stream comprising carbon dioxide, and at least one of carbon monoxide, oxygen, a heavy nitrogen oxide compound, a sulfur oxide compound, and ammonia forming a compressed flue gas stream;
separating the compressed flue gas feed stream in a CO₂ pressure swing adsorption (PSA) unit to form a CO₂-enriched tail gas stream, and an off gas stream;
compressing the CO₂-enriched tail gas stream in a tail gas compressor forming a compressed tail gas stream;
passing the compressed tail gas stream to a reactor comprising a catalyst;
catalytically converting carbon monoxide and oxygen into carbon dioxide in a reactor forming a reactor effluent; and
optionally injecting hydrogen or carbon monoxide or both into the reactor and catalytically converting the carbon monoxide, oxygen, and the hydrogen into carbon dioxide and water in the reactor effluent.
